(19) United States
(12) Patent Application Publication
(10) Pub. No.: US 2026/0022038 A1
(43) Pub. Date: Jan. 22, 2026

(54) CAPACITIVE DEIONIZATION OF WATER USING EFFECTIVE ELECTRODES AND METHODS OF PREPARATION THEREOF

(71) Applicant: King Abdulaziz University, Jeddah (SA)

(72) Inventors: Humair HUSSAIN, Jeddah (SA); Asim JILANI, Jeddah (SA); Mohammad Omaish ANSARI, Jeddah (SA); Adnan MEMIC, Jeddah (SA); Ahmed Salem ALSHAHRIE, Jeddah (SA); Numan SALAH, Jeddah (SA)

(73) Assignee: King Abdulaziz University, Jeddah (SA)

(21) Appl. No.: 18/775,687

(22) Filed: Jul. 17, 2024

(51) Int. Cl. C02F 1/461; C02F 1/46; C02F 103/08

(52) U.S. Cl. CPC C02F 1/46114; C02F 1/4604; C02F 2001/46133; C02F 2001/46161; C02F 2103/08; C02F 2201/46135; C02F 2201/46145

(57) ABSTRACT

A working electrode includes an outer layer including carbonized date palm frond carbon nanoparticles having a particle size of less than 100 nanometers (nm), single-wall carbon nanotubes (SWCNTs), and a polyvinylidene fluoride binder. The working electrode further includes a graphite substrate on which the outer layer is disposed. The I_{D}/I_{G} ratio of the electrode measured in the Raman spectrum is 2.0 or greater.

### STATEMENT OF ACKNOWLEDGEMENT

Support provided by Science and Technology Unit, King Abdulaziz University, Kingdom of Saudi Arabia through project UE-41-109 is gratefully acknowledged.

### BACKGROUND

### Technical Field

The present disclosure is directed towards capacitive deionization of water, more particularly, towards capacitive deionization of water using a working electrode including carbon nanoparticles of date palm fronds and 3D carbonized chitosan.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Freshwater shortage is an issue in many countries. In the Middle East (ME), there is less than 500 m³ of water per person on an annual basis. This amount of freshwater in this region is well below the world average of >1500 m³ per person. It is reported that “constantly depleting ground water table in the region has accelerated seawater intrusion, rendering even the available fresh water sources brackish, with average salt concentrations of ˜5 g/L” [R. Sabale, B. Venkatesh, M. Jose, Sustainable water resource management through conjunctive use of groundwater and surface water: a review, Innovative Infrastructure Solutions, 8 (2022) 17]. Consequently, the ME has moved to seawater desalination to support its water requirements. Water desalination is a well-known process and common practice to generate fresh water and can be conducted by different methods. Older desalination plants use evaporation-based methods, electrodialysis, multi-effect distillation, and reverse osmosis, with reverse osmosis technology being used most recently and commonly in sea water desalination plants. These technologies require high power consumption and additional infrastructure costs and are suitable for large volume high salinity seawater desalination; however, there is a need for new technologies that are suited for salt removal from remote, low-volume, and low-salinity brackish water sources, where power consumption, portability, and operational feasibility are challenges.

Capacitive deionization (CDI) is a potential technique to remove dissolved ions from saline water. A CDI device typically includes two high surface area conductive materials separated by a non-conductive porous spacer. When a potential is applied to the electrodes, positively and negatively charged species from the fluid medium are adsorbed onto oppositely charged electrode surfaces. The adsorption is in the form of electrical double layers (EDLs) and is governed by the strength and distribution of the electric field present at the electrode surfaces. Water wastage during the regeneration of the CDI electrodes is lower than that for the reverse osmosis membranes. This fact, combined with the small and modular CDI cell designs, makes the system portable and highly flexible for modifications and additions, making it a viable alternative for brackish water desalination in remote regions.

CDI performance and efficiency are dependent on the type of chosen electrodes. Several materials have been reported as CDI electrodes and have showed varying success. Influential design parameters for electrodes include high surface area, surface energy, addition of ion exchange membranes, and water flow regimes to improve adsorption capacity. Challenges remain in the design of electrodes. Although carbon-based materials have been considered good candidates for CDI electrodes to achieve the aforementioned criteria, there are still constraints to practically implement carbon-based materials as CDI electrodes. To date, no ideal materials are reported so far to have the desired properties for real and scalable applications. Many researchers realized that the use of nanostructured electrodes for the capacitive devices and the absence of any membranes that required high-pressure pumps led to low power requirements to operate the desalination process, making it viable for battery or solar cell operation of the devices. One way to address these challenges could be by developing novel ultrafine carbon-based nanomaterials and electrodes. Many of which have not yet been evaluated for CDI application.

One of the most common carbon materials is activated carbon (AC), which has attracted a lot of interest in many fields and industries, such as petroleum, pharmaceutical, and chemical, mongst others. It is observed that the AC-based materials exhibit excellent adsorption behavior for CDI electrode applications due to their unique electrical and morphological properties. More specifically, activated carbon cloth-based electrodes offer several advantages over other materials, including high conductance and large surface area. The presence of numerous functional groups on AC can further aid in metal ion coordination, selection, and adsorption. The activated carbon can be produced by using different methods such as heating the dried raw material at high temperature and followed by using physical or chemical activations process. Others have tried to improve the desalination performance by introducing nanostructured metal oxides as additives to such carbon-based CDI electrodes. Examples of these oxides include ZnO, TiO₂, SnO₂, Fe₂O₃, and MnO₂; however, limited improvements were obtained. Moreover, the activated carbons were evaluated in their bulk structure and showed only limited CDI performance. In this regard, ultra-fine carbon nanomaterials extracted from biomass might be promising and may be evaluated for this application. Ultra-fine carbon nanomaterials extracted from biomass are a less toxic and more environmentally friendly alternative to traditional carbon materials. Utilizing biomass as a source of nanocarbon converts solid waste materials into a valuable resource that can be used in various applications in recent technologies.

The base CDI electrode should preferably have high electrical conductivity and surface area, making activated carbons a first choice. Carbonaceous materials come in various forms, ranging from graphene to carbon nanotubes, carbon powder, carbon aerogels, carbon cloth, and other custom-made hierarchical porous materials. Each material presents its own benefits and challenges that need to be identified and assessed. The assessment may be based on cost, ease of availability, desalting capacity, utilization flexibility, cell design considerations, and other technical parameters like resistance, chemical stability, hydrophilicity, and the like, to choose a suitable material for a large-scale CDI unit. In addition to the above-mentioned carbon materials, ultrafine carbon nanoparticles produced from carbonized date palms dried fronds may be promising for CDI electrodes. Such fronds can be collected from date trees, which are abundant in countries such as Saudi Arabia. Focus on designing and evaluating CDI electrodes made of emerging ultrafine carbon nanostructures to overcome drawbacks in the art is a worthwhile pursuit. The nanoparticles of date palm fronds produced by the high-energy ball milling technique have potential to be used as CDI electrodes, as they have an almost graphitic structure and excellent dispersibility in different solvents.

Another class of materials that may have great potential to be used as effective CDI electrodes is chitosan, especially if produced in 3D form. There are two distinct cryogelation fabrication approaches: (i) electrodes made by freeze-drying post crosslinking of gel precursors (i.e., freeze-drying approach) and (ii) electrodes made in a frozen solvent via a single-step cryopolymerization step (i.e., freeze-thawing approach) that crosslinks the polymer network. In both cases, the frozen solvent (i.e., aqueous solutions in many cases) acts as the porogen that leaves behind large pores upon the ice thawing.

Three-dimensional (3D) materials with distinct porous and interconnected structures present numerous advantages for water desalination due to their increased surface area, improved mass transfer, and enhanced selectivity. Unlike two-dimensional organic and inorganic materials, the porous structure and the use of conjugated hybrid nanomaterials in three-dimensional materials play a large role in water desalination; however, it is worth considering certain factors before implementing them in large-scale desalination systems, such as fabrication complexity, limited scalability, and potential challenges related to regeneration and fouling. Careful evaluation of these aspects is valuable to harness the full potential of three-dimensional materials for efficient water desalination.

Although several materials have been developed in the past for CDI, there still exists a need to fabricate efficient electrodes for CDI that may circumvent the drawbacks of prior art. Accordingly, an object of the present disclosure is to develop a working electrode including carbon nanoparticles of date palm fronds and 3D carbonized chitosan for use in capacitive deionization of water.

### SUMMARY

In an exemplary embodiment, a working electrode is described. The working electrode includes an outer layer including carbonized date palm frond carbon nanoparticles having a particle size of less than 100 nanometers (nm), single-wall carbon nanotubes (SWCNTs), and a binder. The binder is a polyvinylidene fluoride. The working electrode further includes a graphite substrate on which the outer layer is disposed. The I_{D}/I_{G} ratio of the electrode measured in the Raman spectrum is 2.0 or greater.

In some embodiments, the outer layer of the working electrode includes pores having a diameter of 20 to 2000 nm, globular clusters having the longest dimension of 500 to 5000 nm, and a network of nanowires.

In some embodiments, the carbonized date palm frond carbon nanoparticles have a Brunauer-Emmett-Teller surface area of 900 to 1500 meters square per gram (m²/g).

In another exemplary embodiment, a method of making the carbonized date palm frond carbon nanoparticles is described. The method includes carbonizing the date palm fronds at a temperature of 350 to 450 degrees Celsius (° C.) for 2 to 4 hours (h), ball milling the carbonized date palm fronds for 0.5 to 16 h at a speed of 150 to 250 revolutions per minute (rpms), and mixing the ball milled carbonized date palm fronds with a base in water to form a solution. The ball milled carbonized date palm fronds and the base have a weight ratio of 1:3 to 1:5. The method further includes heating the solution at a temperature of 550 to 650° C. for 1 to 3 h to form the chemically active carbon nanoparticles of date palm fronds.

In yet another exemplary embodiment, a method of making a working electrode is described. The method includes dissolving the polyvinylidene fluoride in a polar solvent, mixing the chemically active carbon nanoparticles of date palm fronds and the SWCNTs with the polyvinylidene fluoride in the polar solvent to form a mixture, and sonicating the mixture to form a slurry. The method further includes depositing the slurry on the graphite substrate, and drying the slurry on the graphite substrate at a temperature of 100 to 120° C. for 4 to 6 h to form the working electrode. A weight ratio of the chemically active carbon nanoparticles of date palm fronds to the SWCNTs to the polyvinylidene fluoride is from 25 to 30:0.5 to 2:1 to 3.

In yet another exemplary embodiment, a method of desalination is described. The method includes contacting the working electrode, a reference electrode, and a counter electrode with an aqueous solution in a feed tank. The reference electrode is a silver/silver chloride (Ag/AgCl) electrode, and the counter electrode is a platinum electrode. The aqueous solution includes one or more salts. The method further includes connecting the working electrode, the reference electrode, and the counter electrode to a potentiostat, circulating the aqueous solution through the feed tank, applying a potential to the working electrode, and absorbing the one or more salts.

In some embodiments, the method of circulating the aqueous solution occurs at a rate of 15 to 20 mL/minute.

In some embodiments, the applied voltage is from 1.5 to 1.7 volts (V) vs. Ag/AgCl.

In some embodiments, the aqueous solution has an initial concentration of the one or more salts of 1000 parts per million (ppm), and the working electrode has a salt adsorption capacity of 120 to 130 milligrams per gram (mg/g).

In some embodiments, the aqueous solution has an initial concentration of the one or more salts of 1000 ppm, and the working electrode has an ion removal rate of 0.45 to 0.50 milligrams per gram per second (mg/g/s).

In some embodiments, the aqueous solution has an initial concentration of the one or more salts of 1000 ppm, and the working electrode has a salt adsorption capacity of at least 80% of an initial salt adsorption capacity after 50 cycles, wherein one cycle is 900 seconds (s).

In some embodiments, the working electrode has a specific capacitance of 230 to 300 Farad per gram (F/g) at a scan rate of 5 millivolts per second (mV/sec).

In some embodiments, the working electrode has a charge transfer resistance of 5 to 7 ohms (Ω).

In some embodiments, a working electrode is described. The working electrode includes an outer layer including a carbonized chitosan cryopolymerized material, SWCNTs, and a linker. The linker is a glutaraldehyde, and a graphite substrate on which the outer layer is disposed.

In some embodiments, the outer layer of the working electrode is three-dimensional and includes nanopores, micropores, ridges, and valleys, wherein the ridges are 200 to 700 micrometers (μm) in length and the valleys are 50 to 300 μm in width between the ridges.

In yet another exemplary embodiment, a method of making the working electrode is described. The method includes dissolving the chitosan in an acidic solution, sonicating the SWCNTs with the chitosan in the acidic solution, mixing the glutaraldehyde with the SWCNTs and the chitosan in the acidic solution to form a mixture, depositing the mixture on the graphite substrate, freezing the mixture on the graphite at a first temperature of −10 to −30° C. for 20 to 28 h, freezing the mixture on the graphite at a second temperature of −35 to −45° C. for 20 to 28 h, and carbonizing the mixture on the graphite substrate at a temperature of 300 to 400° C. for 1 to 3 h to form the working electrode.

In yet another exemplary embodiment, a method of desalination is described. The method includes contacting the working electrode, a reference electrode, and a counter electrode with an aqueous solution in a feed tank. The reference electrode is a silver/silver chloride (Ag/AgCl) electrode, and the counter electrode is a platinum electrode. The aqueous solution includes one or more salts. The method further includes connecting the working electrode, the reference electrode, and the counter electrode to a potentiostat, circulating the aqueous solution through the feed tank, applying a potential to the working electrode, and absorbing the one or more salts.

In some embodiments, the aqueous solution has an initial concentration of the one or more salts of 1000 ppm, and the working electrode has a salt adsorption capacity of 45 to 55 mg/g.

In some embodiments, the aqueous solution has an initial concentration of the one or more salts of 1000 ppm, and the working electrode has a salt adsorption capacity of at least 80% of an initial salt adsorption capacity after 50 cycles, wherein one cycle is 900 s.

In some embodiments, the working electrode has a specific capacitance of 130 to 140 F/g at a scan rate of 5 mV/sec.

The foregoing general description of the illustrative present disclosure and the following detailed description thereof are merely exemplary aspects of the teachings of this disclosure and are not restrictive. These and other aspects of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A more complete appreciation of the present disclosure (including alternatives and/or variations thereof) and many of the attendant advantages thereof will be readily obtained as the same becomes better understood by reference to the following detailed description of the embodiments when considered in connection with the accompanying drawings, wherein:

FIG. 1A is a method flowchart for making carbonized date palm frond carbon nanoparticles, according to certain embodiments;

FIG. 1B is a method flowchart for making a working electrode consisting of activated carbon nanoparticles of date palm fronds, according to certain embodiments;

FIG. 1C is a method flowchart for desalination using the working electrode, according to certain embodiments;

FIG. 1D is a method flowchart for making a working electrode consisting of 3D carbonized chitosan, according to certain embodiments;

FIG. 1E is a schematic representation of a batch mode setup and capacitive deionization (CDI) cell design, according to certain embodiments;

FIG. 2A is a scanning electron microscopy (SEM) image of carbon nanoparticles before ball milling, according to certain embodiments;

FIG. 2B is an SEM image of carbon nanoparticles after ball milling for 1 hour, according to certain embodiments;

FIG. 2C is an SEM image of carbon nanoparticles after ball milling for 7 hours, according to certain embodiments;

FIG. 2D is an SEM image of carbon nanoparticles after ball milling for 15 hours, according to certain embodiments;

FIG. 3A is an SEM image of the fabricated electrodes made of chemically activated carbon nanoparticles from date palm fronds without ball milling (C-AC), according to certain embodiments;

FIG. 3B is an SEM image of the fabricated electrodes made of chemically activated carbon nanoparticles from date palm fronds after ball milling for 1 hour (CBM01), according to certain embodiments;

FIG. 3C is an SEM image of the fabricated electrodes made of chemically activated carbon nanoparticles from date palm fronds after ball milling for 7 hours (CBM07), according to certain embodiments;

FIG. 3D is an SEM image of the fabricated electrodes made of chemically activated carbon nanoparticles from date palm fronds after ball milling for 15 hours (CBM15), according to certain embodiments;

FIG. 4A is Raman spectra of the electrodes made of the C-AC, CBM01, CBM07, and CBM15, according to certain embodiments;

FIG. 4B shows I_{D}/I_{G} ratios of the electrodes made of the C-AC, CBM01, CBM07, and CBM15, according to certain embodiments;

FIG. 5A shows a Barrett, Joyner, and Halenda (BJH) pore-size distribution curve for the electrodes made of the C-AC, CBM01, CBM07, and CBM15, according to certain embodiments;

FIG. 5B shows nitrogen adsorption/desorption isotherms in the relative pressure range of 0.02 to 0.99 for the electrodes made of the C-AC, CBM01, CBM07, and CBM15, according to certain embodiments;

FIG. 6A shows the desalination performance of the electrodes made of the C-AC, CBM01, CBM07, and CBM15, according to certain embodiments;

FIG. 6B is the ion removal capacity and maximum ion removal rate of the electrodes made of C-AC, CBM01, CBM07, and CBM15, according to certain embodiments;

FIG. 6C is salt absorption capacity (SAC) at different concentrations (200 to 5000 ppm) of the electrodes made of C-AC, CBM01, CBM07, and CBM15, according to certain embodiments;

FIG. 6D shows stability and salt retention of the electrodes made of C-AC, CBM01, CBM07 and CBM15 at 1000 ppm, according to certain embodiments;

FIG. 7A is a cyclic voltammogram (CV) for the electrodes made of C-AC, CBM01, CBM07, and CBM15 in the potential window range −0.6 to 0.6 V vs. Ag/AgCl at a scan rate of 5 mV s⁻¹, according to certain embodiments;

FIG. 7B is a specific capacitance of the C-AC, CBM01, CBM07, and CBM15 electrodes at a scan rate of 5 mV s⁻¹, according to certain embodiments;

FIG. 7C is a specific capacitance of the C-AC, CBM01, CBM07, and CBM15 electrodes at different scan rates, according to certain embodiments;

FIG. 7D is an electrochemical impedance spectroscopy (EIS) curve of the C-AC, CBM01, CBM07, and CBM15 electrodes, according to certain embodiments;

FIG. 8A is an SEM image of an electrode made of carbonized chitosan at a magnification of 150×, according to certain embodiments;

FIG. 8B is an SEM image of the electrode made of carbonized chitosan at a magnification of 120,000×, according to certain embodiments;

FIG. 9 is a Raman spectrum of the electrode made of the produced carbonized chitosan, according to certain embodiments;

FIG. 10A shows a BJH pore-size distribution curve for the produced CDI electrode made of carbonized chitosan, according to certain embodiments;

FIG. 10B shows nitrogen adsorption/desorption isotherms in the relative pressure range 0.02 to 0.99 for the produced CDI electrode made of carbonized chitosan, according to certain embodiments;

FIG. 11A is desalination performance of the CDI electrode made of the carbonized chitosan, according to certain embodiments;

FIG. 11B is SAC at different concentrations (200 to 5000 ppm) of the CDI electrode made of the carbonized chitosan, according to certain embodiments;

FIG. 11C shows stability and salt retention after 50 cycles recorded at 1000 ppm of the CDI electrode made of the carbonized chitosan, according to certain embodiments;

FIG. 12A shows CVs at different scan rates in the potential window range −0.1 to 0.1 V vs. Ag/AgCl using the CDI electrode made of carbonized chitosan, according to certain embodiments;

FIG. 12B shows specific capacitance values at a fixed salt concentration of 1000 ppm using the CDI electrode made of carbonized chitosan, according to certain embodiments; and

FIG. 12C shows EIS in the presence of 0.5 M NaCl electrolyte, according to certain embodiments.

### DETAILED DESCRIPTION

In the following description, it is understood that other embodiments may be utilized, and structural and operational changes may be made without departure from the scope of the present embodiments disclosed herein.

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

Reference will now be made in detail to specific embodiments or features, examples of which are illustrated in the accompanying drawings. In the drawings, wherever possible, corresponding or like reference numerals will be used to designate identical or corresponding parts throughout the several views to refer to the same or corresponding parts. Moreover, references to various elements described herein, are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

The use of the terms “include,” “includes,” “including,” “have,” “has,” or “having” should be generally understood as open-ended and non-limiting unless specifically stated otherwise.

As used herein, “nanoparticles” are particles having a particle size of 1 nm to 500 nm within the scope of the present invention.

As used herein, “particle size” and “pore size” may be thought of as the lengths or longest dimensions of a particle and of a pore opening, respectively.

As used herein, the term “room temperature” refers to a temperature range of 25±3° C. in the present disclosure.

As used herein, the term “electrode” refers to an electrical conductor that contacts a non-metallic part of a circuit, such as a semiconductor, an electrolyte, a vacuum, or air.

As used herein, the term “current density” refers to the amount of electric current traveling per unit cross-section area.

As used herein, the term “capacitive deionization (CDI)” is a technology/technique to remove dissolved ions from saline water by applying an electrical potential difference over two electrodes.

As used herein, the term “carbonization” is a process by which organic materials are converted into solid residues with increasing contents of carbon. Carbonization usually occurs by pyrolysis in an inert atmosphere.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed toward CDI electrodes made of two different starting materials, namely (a) carbon nanoparticles (CNPs) of date palm fronds and (b) 3D carbonized chitosan. The materials are then prepared into working electrodes to be used for desalination application. The results show that the CDI electrodes made of the CNPs of date palm fronds or from 3D carbonized chitosan are suitable for the removal of salt ions from brackish water or other sources to produce high amounts of fresh water.

According to a first aspect of the present disclosure, a working electrode is described. The working electrode includes an outer layer including carbonized date palm frond carbon nanoparticles (also referred to as chemically active carbon nanoparticles of date palm fronds) having a particle size of less than 100 nanometers (nm), preferably less than 80 nm, and preferably less than 60 nm, single-wall carbon nanotubes (SWCNTs), and a binder. In some embodiments, the outer layer of the working electrode includes pores having a diameter of 20-2000 nm, preferably 200-1800 nm, preferably 400-1600 nm, preferably 600-1400 nm, and preferably 800-1200 nm, globular clusters having a longest dimension of 500-5000 nm, preferably 1000-4500 nm, preferably 1500-4000 nm, preferably 2000-3500 nm, and preferably 2500-3000 nm, and a network of nanowires. In alternate embodiments, the outer layer of the working electrode may have a network of nanoshapes, such as nanorods, nanocrystals, nanosquares, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, and the like, and mixtures thereof.

The working electrode includes carbonized date palm frond carbon nanoparticles. The carbonized date palm frond carbon nanoparticles have a particle size of less than 100 nm, preferably less than 90 nm, preferably less than 85 nm, preferably less than 80 nm, preferably less than 75 nm, preferably less than 70 nm, preferably less than 65 nm, and preferably less than 60 nm. In some embodiments, the carbonized date palm frond carbon nanoparticles have a Brunauer-Emmett-Teller (BET) surface area of 900-1500 meters square per gram (m²/g), preferably 1000-1400 m²/g, preferably 1100-1300 m²/g, and preferably 1150-1250 m²/g. In a preferred embodiment, the carbonized date palm frond carbon nanoparticles have a BET surface area of about 1200 m²/g.

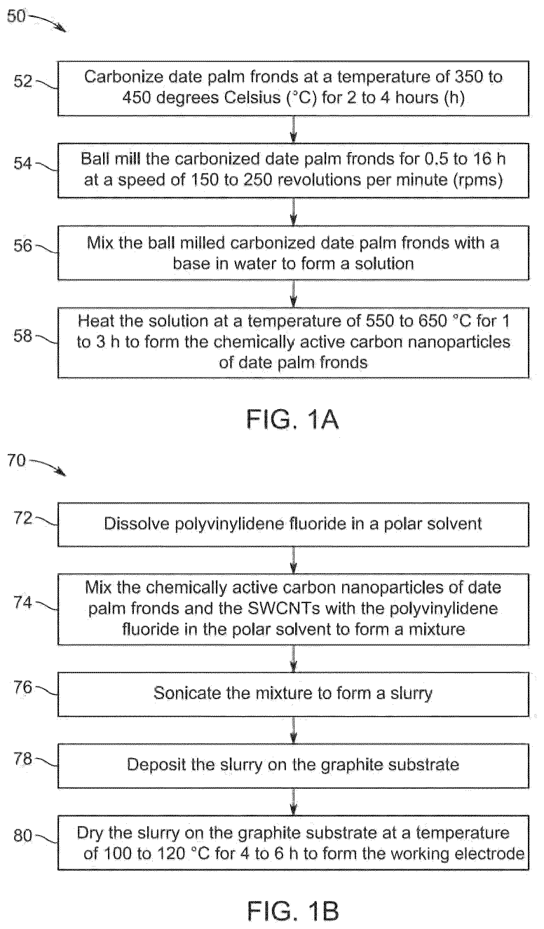

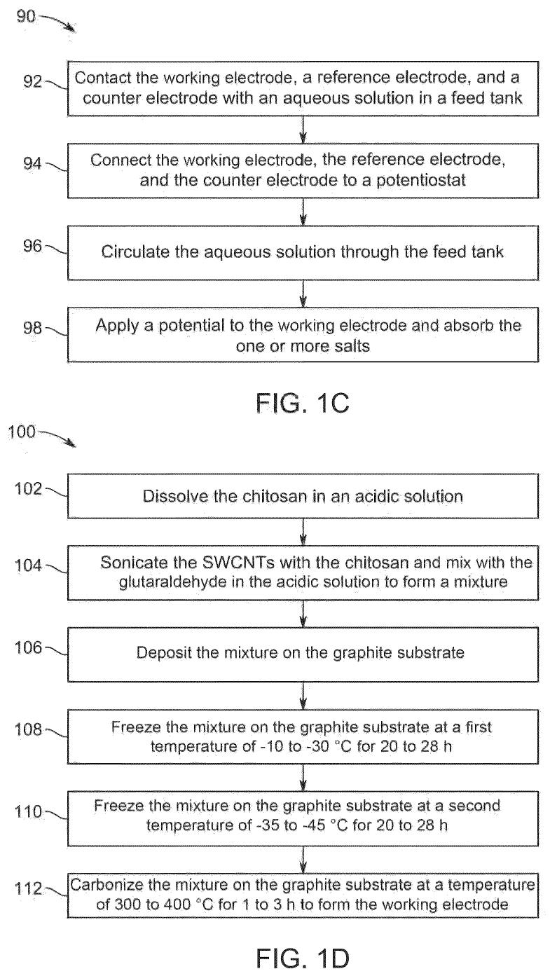

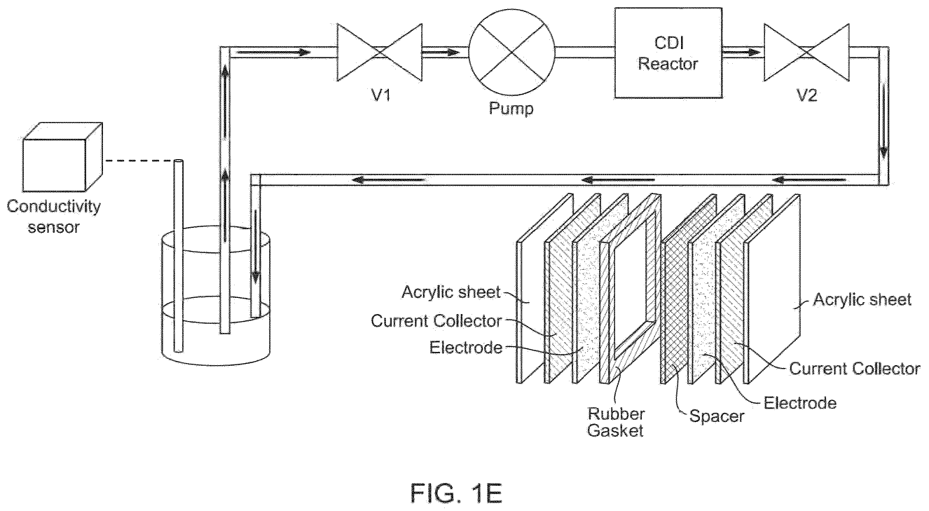

FIG. 1A illustrates a flow chart of a method 50 of making carbonized date palm frond carbon nanoparticles. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes carbonizing the date palm fronds at a temperature of 350-450 degrees Celsius (° C.), preferably 360-440° C., preferably 370-430° C., preferably 380-420° C., more preferably 390-410° C., and yet more preferably about 400° C. for 2-4 hours (h), preferably 2.5-3.5 h, and more preferably about 3 h. Carbonizing or carbonization is a process by which solid residues with an increasing content of carbon are formed from organic material, usually by pyrolysis in an inert atmosphere. In a preferred embodiment, the carbonizing of the date palm fronds occurs at a temperature of 400° C. for 3 h.

At step 54, the method 50 includes ball milling the carbonized date palm fronds for 0.5-16 h, preferably 1.0-15 h, preferably 2-14 h, preferably 3-13 h, preferably 4-12 h, preferably 5-11 h, preferably 6-10 h, preferably 7-9 h at a speed of 150-250 revolutions per minute (rpms), preferably 160-240 rpms, preferably 170-230 rpms, preferably 180-220 rpms, more preferably 190-210 rpms, and yet more preferably about 200 rpms. In alternate embodiments, the grinding may be carried out using any suitable means, for example, blending, and the like, using manual methods (e.g., mortar and the like) or machine-assisted methods, such as using a mechanical blender, or any other apparatus known to those of ordinary skill in the art. In a preferred embodiment, the ball milling of the carbonized date palm fronds is done for 1 h at a speed of 200 rpms.

At step 56, the method 50 includes mixing the ball milled carbonized date palm fronds with a base in water to form a solution. In some embodiments, the ball milled carbonized date palm fronds and the base have a weight ratio of 1:3 to 1:5, preferably 1:3.5 to 1:4.5, and more preferably about 1:4. In a preferred embodiment, the ball milled carbonized date palm fronds and the base have a weight ratio of 1:4. In some embodiments, the base is selected from the group consisting of an alkaline earth metal hydroxide such as beryllium hydroxide (Be(OH)₂), magnesium hydroxide (Mg(OH)₂), strontium hydroxide (Sr(OH)₂), and calcium hydroxide (Ca(OH)₂), and an alkali metal hydroxide such as lithium hydroxide (LiOH), sodium hydroxide (NaOH), potassium hydroxide (KOH), rubidium hydroxide (RbOH), and cesium hydroxide (CsOH). In a preferred embodiment, the base is KOH. The water may be tap water, distilled water, bi-distilled water, deionized water, deionized distilled water, reverse osmosis water, and/or any other water. In a preferred embodiment, the water is deionized water. The mixing may be carried out manually or with the help of a stirrer.

At step 58, the method 50 includes heating the solution at a temperature of 550-650° C., preferably 560-640° C., preferably 570-630° C., preferably 580-620° C., more preferably 590-610° C., and yet more preferably about 600° C. for 1-3 h, preferably 1.5-2.5 h, more preferably 1.75-2.25 h, and yet more preferably about 2 h to form the chemically active carbon nanoparticles of date palm fronds. The heating can be done by using heating appliances such as hot plates, muffle furnace, heating mantles ovens, microwaves, autoclaves, and tapes, oil baths, salt baths, sand baths, air baths, hot-tube furnaces, hot-air guns, and the like. In a preferred embodiment, the solution is heated in a muffle furnace at a temperature of 600° C. for 2 h.

The working electrode further includes a polymer binder. In some embodiments, the polymer binder is at least one selected from the group consisting of a styrene-butadiene rubber, a polyvinylidene fluoride (PVDF), and a polyvinylidene fluoride copolymer. Other suitable examples of fluorinated polymers include polytetrafluoroethylene (PTFE), polyethylene chlorotrifluoroethylene (ECTFE), polyethylene tetrafluoroethylene (ETFE), fluorinated-ethylene-propylene (FEP), perfluoro-alkoxy (PFA), polychlorotrifluoroethylene (PCTFE), sulfonated tetrafluoroethylene (Nafion™), and the like, and combinations thereof. In a preferred embodiment, the polymer binder is PVDF.

The working electrode further includes a graphite substrate on which the outer layer is disposed. The I_{D}/I_{G} ratio of the electrode measured in the Raman spectrum is 2.0 or greater, preferably 2.2 or greater, preferably 2.4 or greater, preferably 2.6 or greater, more preferably 2.8 or greater, and preferably 3.0. In a preferred embodiment, the I_{D}/I_{G} ratio of the electrode measured in the Raman spectrum is about 2.85.

FIG. 1B illustrates a flow chart of a method 70 of making the working electrode consisting of activated carbon nanoparticles of date palm fronds. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes dissolving the polyvinylidene fluoride in a polar solvent. The dissolution may be carried out manually, via stirring, via sonication, and the like. The dissolution is carried out until the particles are fully dissolved in the solvent and a homogenous solution is obtained. Suitable examples of polar solvents include water, methanol, ethanol, acetone, dimethyl sulfoxide (DMSO), dimethylformamide, dimethylacetamide, isopropanol, and the like. The water may be tap water, distilled water, bi-distilled water, deionized water, deionized distilled water, reverse osmosis water, and/or some other water. In a preferred embodiment, the polar solvent is DMSO.

At step 74, the method 70 includes mixing the chemically active carbon nanoparticles of date palm fronds and the SWCNTs with the PVDF in the polar solvent to form a mixture. Suitable examples of polar solvents include water, methanol, ethanol, acetone, dimethyl sulfoxide (DMSO), dimethylformamide, dimethylacetamide, and isopropanol. The water may be tap water, distilled water, bi-distilled water, deionized water, deionized distilled water, reverse osmosis water, and/or some other water. In some embodiments, a weight ratio of the chemically active carbon nanoparticles of date palm fronds to the SWCNTs is from 25 to 30:0.5 to 2, preferably 26 to 29:0.6 to 1.6, more preferably 27 to 28:0.8 to 1.4, and yet more preferably about 27:1. In some embodiments, a weight ratio of the SWCNTs to the polyvinylidene fluoride is from 0.5 to 2:1 to 3, preferably 0.6 to 1.6:1.5 to 2.5, more preferably 0.8 to 1.4:1.75 to 2.25, and yet more preferably about 1:2. In a preferred embodiment, a weight ratio of the chemically active carbon nanoparticles of date palm fronds to the SWCNTs to the polyvinylidene fluoride is 27:1:2.

At step 76, the method 70 includes sonicating the mixture to form a slurry. The sonicating and homogenization can be performed ultrasonically for a time range of preferably 6-14 min, preferably 7-13 min, preferably 8-12 min, more preferably 9-11 min, and yet more preferably about 10 min. In a preferred embodiment, the mixture was ultra-sonicated for 10 minutes to achieve a homogeneous slurry.

At step 78, the method 70 includes depositing the slurry on the graphite substrate. The deposition may be done by drop-casting method, spray coating, spin coating, or dip coating. The particles cover at least 50%, preferably 55%, preferably 60%, preferably 65%, preferably 70%, preferably 75%, preferably 80%, preferably 85%, more preferably 90%, and yet more preferably more than 95% of the graphite substrate. In alternate embodiments, the graphite substrate is at least one selected from the group consisting of an aluminum substrate, a nickel substrate, a titanium substrate, a titanium alloy substrate, an aluminum alloy substrate, a magnesium alloy substrate, a nickel alloy substrate, and a steel substrate. In an embodiment, the graphite substrate is any suitable substrate for electrochemical processes known in the art.

At step 80, the method 70 includes drying the slurry on the graphite substrate at a temperature of 100-120° C., preferably 102-118° C., preferably 104-116° C., preferably 106-114° C., more preferably 108-112° C., and yet more preferably about 110° C. for 4-6 h, preferably 4.25-5.75 h, preferably 4.5-5.5 h, more preferably 4.75-5.25 h, and yet more preferably about 5 h to form the working electrode. The drying can be done by using heating appliances such as hot plates, heating mantles ovens, microwaves, autoclaves, tapes, oil baths, salt baths, sand baths, air baths, hot-tube furnaces, hot-air guns, and any drying techniques known in the art. In a preferred embodiment, the slurry on the graphite substrate is dried at a temperature of 110° C. for 5 h.

FIG. 1C illustrates a flow chart of a method 90 of desalination using the working electrode consisting of activated carbon nanoparticles of date palm fronds. The order in which the method 90 is described is not intended to be construed as a limitation, and any number of the described method steps can be combined in any order to implement the method 90. Additionally, individual steps may be removed or skipped from the method 90 without departing from the spirit and scope of the present disclosure.

At step 92, the method 90 includes contacting the working electrode, a reference electrode, and a counter electrode with an aqueous solution in a feed tank. A reference electrode is an electrode that has a stable and well-known electrode potential. The high stability of the electrode potential is reached by employing a redox system with constant (buffered and/or saturated) concentrations of each relevant species of the redox reaction. A reference electrode may enable a potentiostat to deliver a stable voltage to the working electrode and/or the counter electrode. The reference electrode may be a standard hydrogen electrode (SHE), a normal hydrogen electrode (NHE), a reversible hydrogen electrode (RHE), a saturated calomel electrode (SCE), a copper/copper(II) sulfate electrode (CSE), a silver/silver chloride electrode (Ag/AgCl), a pH-electrode, a palladium-hydrogen electrode, a dynamic hydrogen electrode (DHE), a mercury/mercurous sulfate electrode (Hg/HgSO₄), mercury/mercuric oxide (Hg/HgO) electrode, and any other type of reference electrode known in the art. In a preferred embodiment, a reference electrode is an Ag/AgCl electrode. However, in some embodiments, the electrochemical cell does not include a third electrode.

In some embodiments, the counter electrode is made from a material selected from the group consisting of platinum, gold, and carbon. In some embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, and more preferably at most 10⁻⁸ Ω·m at a temperature of 20-25° C. The form of the counter electrode may be generally relevant only in that it needs to supply sufficient current to the electrolyte solution to support the current required for the electrochemical reaction of interest. In some embodiments, the form of the counter electrode may be a wire, a rod, a flag, a sheet, a mesh, and the like. The counter electrode material should thus be sufficiently inert to withstand the chemical conditions in the electrolyte solution, such as acidic or basic pH values, without substantially degrading during the electrochemical reaction. The counter electrode should preferably not leach out any chemical substance that interferes with the electrochemical reaction or might lead to undesirable electrode contamination. In a preferred embodiment, the counter electrode is platinum.

In some embodiments, the aqueous solution includes one or more salts. Suitable examples of salts include sodium fluoride, sodium chloride, sodium bromide, sodium iodide, sodium sulfate, sodium acetate, and the like. In some embodiments, the aqueous solution may contain any salt known in the art. In a preferred embodiment, the salt is NaCl.

At step 94, the method 90 includes connecting the working electrode, the reference electrode, and the counter electrode to a potentiostat. A reference electrode may enable a potentiostat to deliver a stable voltage to the working electrode or the counter electrode and allow for results of electrochemical experiments to be compared to other results.

At step 96, the method 90 includes circulating the aqueous solution through the feed tank. In some embodiments, circulating occurs at a rate of 15-20 mL/minute, preferably 16-19 mL/minute, and more preferably 17-18 mL/minute.

At step 98, the method 90 includes applying a potential to the working electrode and absorbing the one or more salts. In some embodiments, the applied voltage is from 1.5-1.7 volts (V), preferably 1.55-1.65 V, and more preferably about 1.6 V vs. Ag/AgCl. The aqueous solution has an initial concentration of the one or more salts of 800 to 1200 parts per million (ppm), preferably 900 to 1100 ppm, and more preferably about 1000 ppm, and the working electrode has a salt adsorption capacity of 120-130 milligrams per gram (mg/g), preferably 121-129 mg/g, preferably 122-128 mg/g, more preferably 123-127 mg/g, and yet more preferably 124-126 mg/g. In a preferred embodiment, the aqueous solution has an initial concentration of one or more salts of 1000 ppm, and the working electrode has a salt adsorption capacity of 124 mg/g. In some embodiments, the aqueous solution has an initial concentration of one or more salts of 800 to 1200 ppm, preferably 900 to 1100 ppm, and more preferably about 1000 ppm, and the working electrode has an ion removal rate of 0.45-0.50 milligrams per gram per second (mg/g/s), preferably 0.46-0.49 mg/g/s, and more preferably about 0.47-0.48 mg/g/s. In some embodiments, the aqueous solution has an initial concentration of one or more salts of 800 to 1200 ppm, preferably 900 to 1100 ppm, and more preferably about 1000 ppm, and the working electrode has a salt adsorption capacity of at least 80%, preferably at least 85%, more preferably at least 90%, and yet more preferably at least 95% of an initial salt adsorption capacity after 50 cycles. In some embodiments, one cycle is 600 to 1200 seconds (s), preferably 700 to 1100 s, more preferably 800 to 1000 s, and yet more preferably about 900 s. In a preferred embodiment, one cycle is 900 seconds.

In some embodiments, the working electrode has a specific capacitance of 230-300 Farad per gram (F/g), preferably 240-290 F/g, preferably 250-280 F/g, and preferably 260-270 F/g at a scan rate of 5 millivolts per second (mV/sec). In a preferred embodiment, the working electrode has a specific capacitance of 291.66 F/g at a scan rate of 5 mV/sec. In some embodiments, the working electrode has a charge transfer resistance of 5-7 ohms (Ω), preferably 5.25-6.75Ω, more preferably 5.5-6.5Ω, and yet more preferably 5.75-6.25Ω.

According to a second aspect of the present disclosure, another working electrode is described. The working electrode includes an outer layer including a carbonized chitosan cryopolymerized material, SWCNTs, and a linker. The linker is a glutaraldehyde. In some embodiments, the linker may be any linker known in the art. The outer layer is disposed on a graphite substrate. In alternate embodiments, the graphite substrate is at least one selected from the group consisting of an aluminum substrate, a nickel substrate, a titanium substrate, a titanium alloy substrate, an aluminum alloy substrate, a magnesium alloy substrate, a nickel alloy substrate, and a steel substrate. In an embodiment, the graphite substrate is any suitable substrate for electrochemical processes known in the art.

In some embodiments, the outer layer of the working electrode is three-dimensional (3D) and includes nanopores, micropores, ridges, and valleys, wherein the ridges are 200-700 micrometers (μm), preferably 250-650 μm, preferably 300-600 μm, more preferably 350-550 μm, and yet more preferably about 400-500 μm in length and the valleys are 50-300 μm, preferably 100-250 μm, and more preferably about 150-200 μm in width between the ridges.

FIG. 1D illustrates a flow chart of a method 100 of making the working electrode consisting of 3D carbonized chitosan. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes dissolving the chitosan in an acidic solution. Chitosan is a biodegradable polymer derived from chitin (C₈H₁₃O₅N)ₙ and has been used in the development of some products like antimicrobial films for food storage/packaging. Chitin is considered the second most abundant polysaccharide in nature, after cellulose, with a production rate of around 1 billion tons each year in the biosphere. This material is a long-chain polymer of N-acetylglucosamine, an amide derivative of glucose. Chitin was also approved for use in wound dressings due to its ability to form a gel. The antimicrobial property of chitosan is useful to utilize the polymer for water treatment and desalination using emerging technologies like CDI, but a proper shape and structure for the polymer to increase its surface area and form CDI electrodes should be defined. The dissolution may be carried out manually, via stirring, via sonication, and/or the like. The dissolution is carried out until the particles are fully dissolved in the solvent and a homogenous solution is obtained. Suitable examples of acids include hydrochloric acid (HCl), sulfuric acid (H2SO4), acetic acid (CH₃COOH), nitric acid (HNO₃), and the like. In a preferred embodiment, the acid is acetic acid (CH₃COOH). In a preferred embodiment, the acidic solution is acetic acid diluted with water. The water may be tap water, distilled water, bi-distilled water, deionized water, deionized distilled water, reverse osmosis water, and/or some other water. In a preferred embodiment, the water is deionized water.

At step 104, the method 100 includes sonicating the SWCNTs with the chitosan in the acidic solution and mixing the glutaraldehyde with the SWCNTs and the chitosan in the acidic solution to form a mixture. The sonicating and homogenization can be performed ultrasonically for 10 to 30 min, preferably 15 to 25 min, and preferably about 20 min. The mixing may be carried out manually or with the help of a stirrer.

At step 106, the method 100 includes depositing the mixture on the graphite substrate. The deposition may be done by drop-casting method, spray coating, spin coating, or dip coating. The particles of the mixture cover at least 50%, preferably 55%, preferably 60%, preferably 65%, preferably 70%, preferably 75%, preferably 80%, preferably 85%, more preferably 90%, and yet more preferably more than 95% of the substrate.

At step 108, the method 100 includes freezing the mixture on the graphite substrate at a first temperature of −10 to −30° C., preferably −11 to −29° C., preferably −12 to −28° C., preferably −13 to −27° C., preferably −14 to −26° C., preferably −15 to −25° C., preferably −16 to −24° C., preferably −17 to −23° C., more preferably −18 to −22° C., and yet more preferably about −19 to −21° C. for 20-28 h, preferably 21-27 h, more preferably 22-26 h, and yet more preferably about 23-25 h. In a preferred embodiment, the freezing of the mixture is done at a first temperature of −20° C. for 24 h.

At step 110, the method 100 includes freezing the mixture on the graphite substrate at a second temperature of −35 to −45° C., preferably −37 to −44° C., more preferably −39 to −43° C., and yet more preferably about −41 to −42° C. for 20-28 h, preferably 21-27 h, more preferably 22-26 h, and yet more preferably about 23-25 h. In a preferred embodiment, the freezing of the mixture is done at a second temperature of −42° C. for 24 h.

At step 112, the method 100 includes carbonizing the mixture on the graphite substrate at a temperature of 300-400° C., preferably 320-380° C., more preferably 340-360° C., and yet more preferably about 350° C. for 1-3 h, preferably 1.5-2.5 h, and more preferably 1.75-2.25 h to form the working electrode. In a preferred embodiment, the mixture is carbonized on the graphite substrate at a temperature of 350° C. for 2 h. During carbonization small pores in the polymer wall structure might be generated. Such small pores can improve the surface area and porosity that play in important role in water desalination and ions adsorption.

In yet another exemplary embodiment, a method of desalination is described. The method includes contacting the working electrode consisting of 3D carbonized chitosan, a reference electrode, and a counter electrode with an aqueous solution in a feed tank. A reference electrode is an electrode that has a stable and well-known electrode potential. The high stability of the electrode potential is usually reached by employing a redox system with constant (buffered and/or saturated) concentrations of each relevant species of the redox reaction. A reference electrode may enable a potentiostat to deliver a stable voltage to the working electrode and/or the counter electrode. The reference electrode may be a standard hydrogen electrode (SHE), a normal hydrogen electrode (NHE), a reversible hydrogen electrode (RHE), a saturated calomel electrode (SCE), a copper/copper(II) sulfate electrode (CSE), a silver/silver chloride Ag/AgCl, a pH-electrode, a palladium-hydrogen electrode, a dynamic hydrogen electrode (DHE), a mercury/mercurous sulfate electrode (Hg/HgSO₄), mercury/mercuric oxide (Hg/HgO) electrode, and any other type of reference electrode known in the art. In a preferred embodiment, the reference electrode is an Ag/AgCl electrode. However, in some embodiments, the electrochemical cell does not include a third electrode.

In some embodiments, the counter electrode is made from a material selected from the group consisting of platinum, gold, and carbon. In some embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10-6 Ω·m, preferably at most 10⁷ Ω·m, and more preferably at most 10⁻⁸ Ω·m at a temperature of 20-25° C. The form of the counter electrode may be generally relevant only in that it needs to supply sufficient current to the electrolyte solution to support the current required for the electrochemical reaction of interest. In some embodiments, the form of the counter electrode may be a wire, a rod, a flag, a sheet, a mesh, and the like. The counter electrode material should thus be sufficiently inert to withstand the chemical conditions in the electrolyte solution, such as acidic or basic pH values, without substantially degrading during the electrochemical reaction. The counter electrode should preferably not leach out any chemical substance that interferes with the electrochemical reaction or might lead to undesirable electrode contamination. In a preferred embodiment, the counter electrode is platinum.

In some embodiments, the aqueous solution includes one or more salts. Suitable examples of salts include sodium fluoride, sodium chloride, sodium bromide, sodium iodide, sodium sulfate, sodium acetate, and the like. In some embodiments, the aqueous solution may contain any salt known in the art. In a preferred embodiment, the salt is NaCl.

The method further includes connecting the working electrode, the reference electrode, and the counter electrode to a potentiostat. A reference electrode may enable a potentiostat to deliver a stable voltage to the working electrode or the counter electrode and allow for results of electrochemical experiments to be compared to other results. The method further includes circulating the aqueous solution through the feed tank, applying a potential to the working electrode, and absorbing one or more salts.

In some embodiments, the aqueous solution has an initial concentration of one or more salts of 800 to 1200 ppm, preferably 900 to 1100 ppm, and more preferably 1000 ppm, and the working electrode has a salt adsorption capacity of 45-55 mg/g, preferably 46-54 mg/g, preferably 47-53 mg/g, more preferably 48-52 mg/g, and yet more preferably 49-51 mg/g. In a preferred embodiment, the aqueous solution has an initial concentration of one or more salts of 1000 ppm, and the working electrode has a salt adsorption capacity of 50 mg/g. In some embodiments, the aqueous solution has an initial concentration of one or more salts of 800 to 1200 ppm, preferably 900 to 1100 ppm, and more preferably 1000 ppm, and the working electrode has a salt adsorption capacity of at least 80%, preferably at least 85%, more preferably at least 90%, and yet more preferably at least 95% of an initial salt adsorption capacity after 50 cycles. In some embodiments, one cycle is 600 to 1200 seconds, preferably 700 to 1100 s, more preferably 800 to 1000 s, and yet more preferably about 900 s. In a preferred embodiment, one cycle is 900 s. In some embodiments, the working electrode has a specific capacitance of 110-130 F/g, preferably 115-129 F/g, preferably 120-128 F/g, preferably 123-127 F/g, more preferably 124-126 F/g, and yet more preferably about 125 F/g at a scan rate of 5 mV/sec.

### EXAMPLES

The following examples describe and demonstrate capacitive deionization (CDI) electrodes. The examples are provided solely for the purpose of illustration and are not to be construed as limitations of the present disclosure, as many variations thereof are possible without departing from the spirit and scope of the present disclosure.

### Example 1: Materials

The date palm fronds were collected from a farm located in Thahban, Jeddah, Saudi Arabia, while the single wall carbon nanotubes (SWCNTs) that have an electrical conductivity of ˜1000 S/cm (in their pellet form) were purchased from Ad-Nano Technologies, Shimoga-Karnataka, India. Poly(vinylidene-fluoride) (PVDF) of MW=180 kg mol⁻¹ and dimethyl sulfoxide (DMSO) were purchased from Sigma-Aldrich, Germany.

### Example 2: Methodology

To produce activated carbon nanoparticles from date palm fronds, the palm fronds were initially cut into small pieces. The cut fronds were then subjected to multiple washing cycles with deionized (DI) water to eliminate impurities and surface contaminants. After thorough cleaning, the fronds were dried overnight in an oven, ensuring the removal of any remaining moisture. Subsequently, the dried fronds were subjected to the carbonization process, which took place inside a closed beaker equipped with small holes in the lid. Carbonization occurred at a temperature of 400° C. for a duration of 3 hours (h).

The carbonized material was split into four groups and each group was balled milled for different times, namely 0, 1, 7, and 15 h, at a speed of 200 rpm. Each of the balled milled samples were separately activated by impregnation with KOH at a ratio of 1:4 (carbon:KOH) in a small amount of DI water for 1 h (5 g of the carbon and KOH powder samples and 10 mL of DI water). The solution, then was heated at 600° C. for 2 h in a muffle furnace. The final product was washed several times with DI water to achieve a solution with neutral pH. These samples, which have been ball milled for different times (0, 1, 7, and 15 h) and chemically activated are named as C-AC, CBM01, CBM07, and CBM15, respectively. The activated samples, which are C-AC, CBM01, CBM07, and CBM15, were measured for their surface area and found to be around 1450, 1200, 1100, and 945 m²/g, respectively. The Brunauer-Emmett-Teller (BET) surface area of the activated carbon materials was calculated in the relative pressure range of 0.05-0.3. Prior to the experiment, the samples were degassed at 300° C. for 3 h. The N₂ adsorption-desorption isotherms of the carbon materials were performed in the relative pressure range 0.02-0.99. The pore profile was investigated using the Barrett, Joyner, and Halenda (BJH) method. The mesopore volume was calculated by subtracting the micropore volume from the total volume of the pores.

### Example 3: Preparation of the CDI Electrodes

Activated CNPs and SWCNTs were used as conductive materials, along with PVDF as a binder, to fabricate the electrode at a ratio of 27:1:2, respectively. The fabrication process involved dissolving PVDF in DMSO at 80° C. for 10 minutes. Subsequently, the desired activated CNPs (e.g., C-AC) and SWCNTs were simultaneously added to the PVDF solution, and the mixture was ultra-sonicated for 10 minutes to achieve a homogeneous slurry. The obtained slurry was then deposited onto a graphite substrate, and the deposited slurry was dried at 110° C. for 5 hours. The resulting electrode had dimensions of 4.5 cm×4.5 cm×50 μm. Similarly, electrodes of CBM01, CBM07, and CBM15 were fabricated using the same procedure.

### Example 4: Electrochemical Characterization

The electrochemical behavior was studied using an electrochemical workstation manufactured by CH Instruments, USA. A typical three-electrode system was employed, consisting of Ag/AgCl as the reference electrode, platinum as the counter electrode, and the electrodes of C-AC, CBM01, CBM07, or CBM15 as the working electrode. Electrochemical impedance spectroscopy (EIS) was used to measure the impedance of the electrodes in response to the AC signal over a frequency range of 1000 kHz to 10 mHz. All experiments were conducted in a 0.5 M NaCl electrolyte. The specific capacitance (C) of the electrodes was calculated using the equation [H. Jiang, L. Yang, C. Li, C. Yan, P. S. Lee, J. Ma, High-rate electrochemical capacitors from highly graphitic carbon-tipped manganese oxide/mesoporous carbon/manganese oxide hybrid nanowires, Energy & Environmental Science, 4 (2011) 1813-1819, which is incorporated herein by reference in its entirety]:

$$C = \int Idt / 2 k Δ Vm \qquad ( 1 )$$

where m is the mass of the electrode (in gram), k is the scan rate (V s⁻¹), ΔV refers to the potential window range, and I denotes the current density (A).

### Example 5: Desalination Test

To investigate the salt adsorption capacity (SAC) of the electrodes made of the C-AC, CBM01, CBM07, and CBM15 samples, the experiment was conducted in a batch-mode setup. The setup consisted of a feed tank containing an NaCl solution, a power supply connected to the unit cell, a multi-meter connected in series, and a peristaltic pump for circulating water from the feed tank to the unit cell and back to the same feed tank (as depicted in FIG. 1E). The conductivity sensor was placed in the feed tank to measure the conductivity of the NaCl solution. Prior to the experiment, the electrodes were short circuited, and waters flowed through CDI unit until it reached equilibrium concentration. The salt adsorption capacity was tested for 200, 500, 1000, 2000, and 5000 ppm of 100 mL NaCl solution at 1.6 V potential difference. The SAC was calculated by measuring the reduction in conductivity of NaCl solution. The change in the conductivity was converted into mg/L and substituted in the equation. This SAC measurement is used for understanding the effectiveness of the electrodes in removing salt from the NaCl solution and evaluating electrode application in capacitive deionization processes for water desalination and purification.

$$SAC ( mg / g ) = ( {C}_{i} - {C}_{f} ) V / m \qquad ( 2 )$$

Cᵢ and C_{f} are the initial and equilibrium concentration of NaCl solution (mg/L), respectively, V is the total volume of the solution, and m is the active mass of the electrodes.

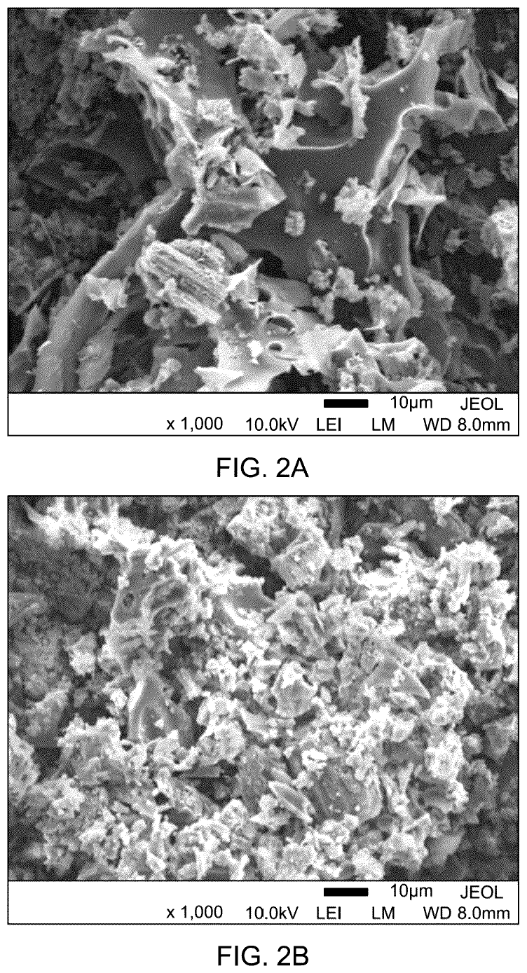

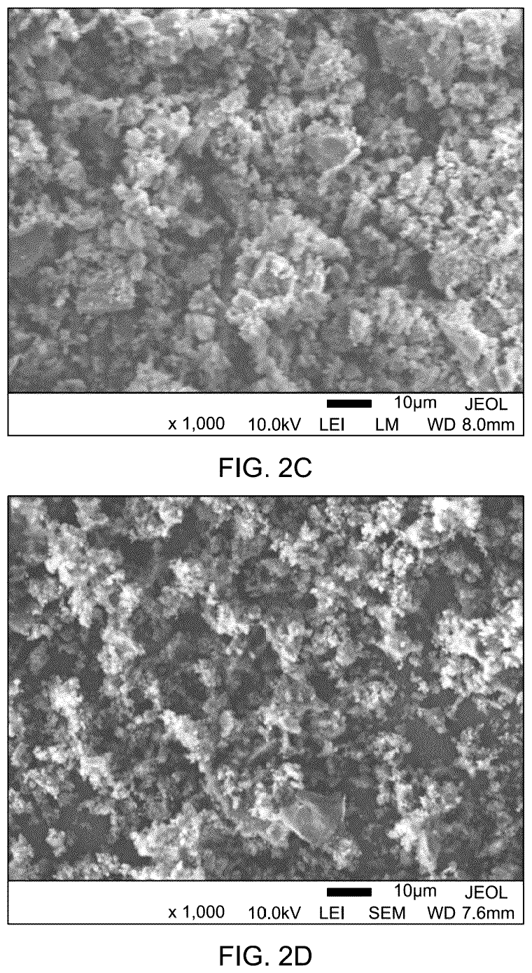

The produced carbon nanoparticles (CNPs) of date palm fronds by the high-energy ball milling technique were studied for their morphology, particle size and shape. FIGS. 2A-2D show SEM images at the same magnifications of the carbonized date palm fronds before ball milling (FIG. 2A) and those ball milled for 1, 7, and 15 h (FIGS. 2B-2D). A systematic reduction in particle size by increasing the ball milling time can be seen. The produced CNPs after ball milling for 15 h are highly uniform and have ultra-finish structures with particle sizes of less than 100 nm.

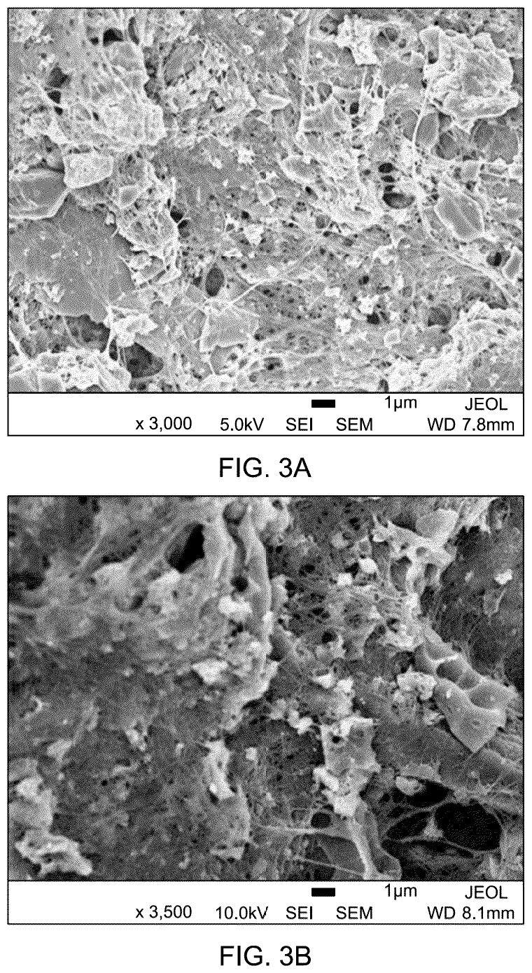

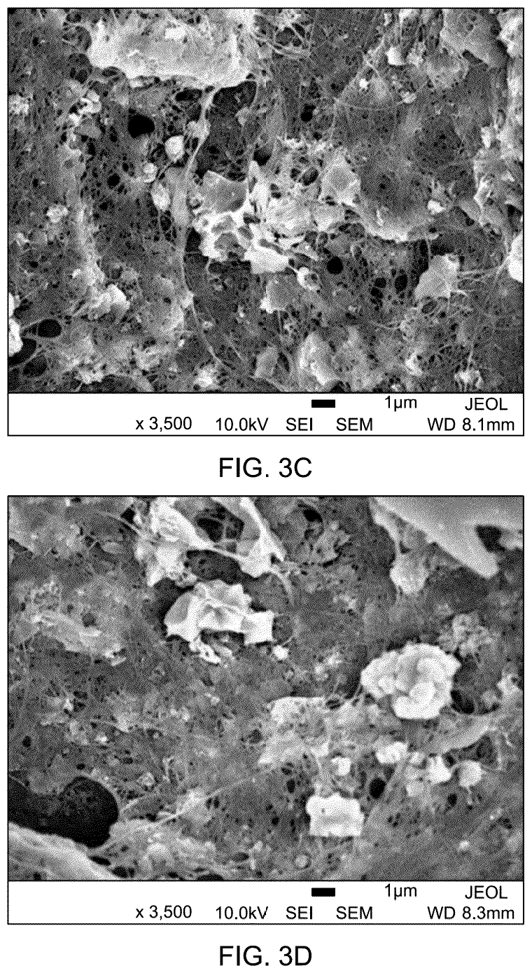

FIGS. 3A-3D show SEM images of the fabricated electrodes made of the C-AC, CBM01, CBM07 and CBM15 samples, respectively. The surface morphology of these electrodes display foam like structures. As can be observed in these images, the activated CNPs are well connected/merged in these electrodes. The SWCNTs are also well distributed in the matrix and connect all parts of the electrodes. Nano- and micro-porosity can also be seen in the electrodes. No distinguishable difference can be observed in the electrode due to the ball milling at different times.

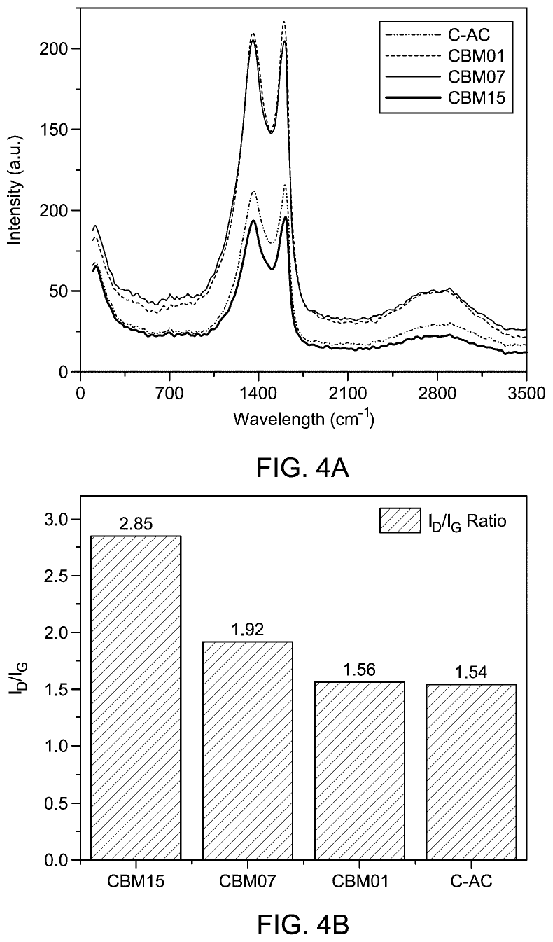

Raman spectra and I_{D}/I_{G} ratios of the electrodes made of the C-AC, CBM01, CBM07, and CBM15 samples are shown in FIG. 4A and FIG. 4B, respectively. The peaks in FIG. 4A show the graphite (G) and defect (D) bands, which normally are observed in all graphitic carbons. The G and D bands are pronounced in each of the electrodes. Smaller bands are also observed below 300 cm⁻¹, which may be the RPM modes of SWCNTs. A change in the I_{D}/I_{G} ratio is observed in the spectra by changing the ball milling time of the samples. This ratio was observed to increase by increasing the ball milling time for the carbonized samples, as can be observed in FIG. 4B. This increase might be due to the reduction and breaking of the long range graphic lattice structures and increase in defective carbon patterns due to the impact of high-energy ball milling.

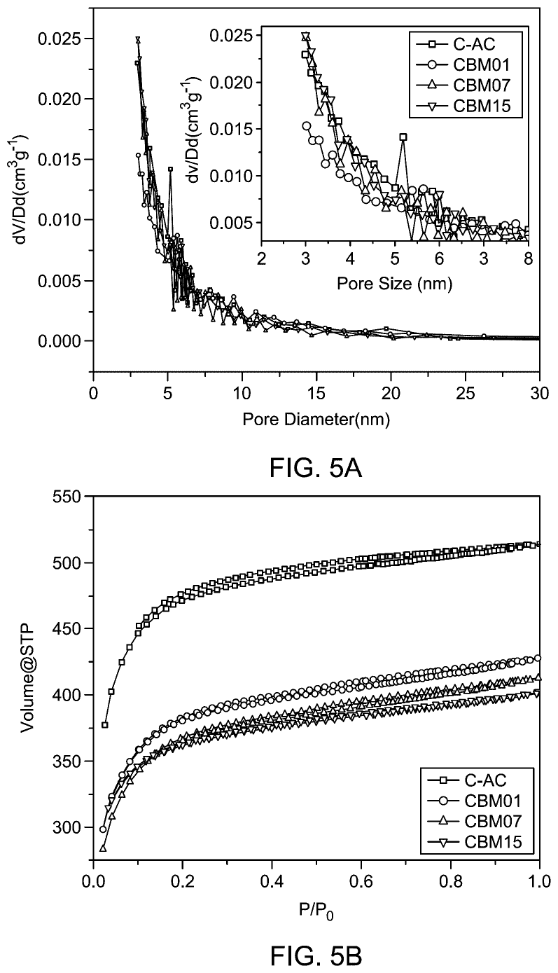

FIGS. 5A-5B show the pore profile of the electrodes made of the C-AC, CBM01, CBM07, and CBM15 samples, which have been investigated using the Barrett, Joyner, and Halenda (BJH) method. The BJH pore size distributions are shown in FIG. 5A, while the nitrogen adsorption/desorption isotherms in the relative pressure range 0.02 to 0.99 are shown in FIG. 5B. The majority of pore diameters are less than 5 nm in the electrodes. The shapes of the isotherm curves are of type-IV with an H4 hysteresis loop, which indicates a mesoporous structure. Moreover, the existence of type H4 hysteresis loops in these electrodes is due to the slit-shaped pores characterized by the chemically activated carbons.

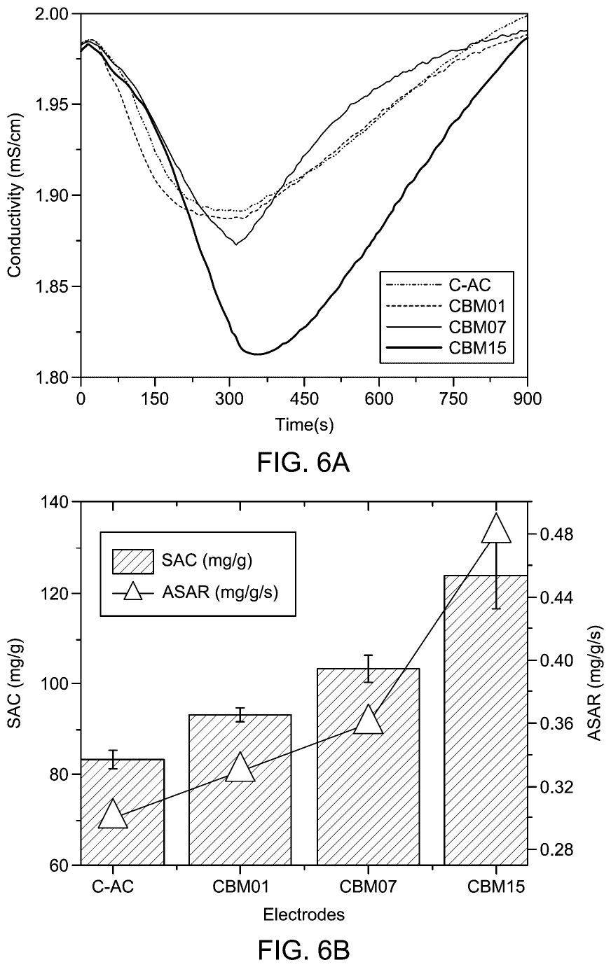

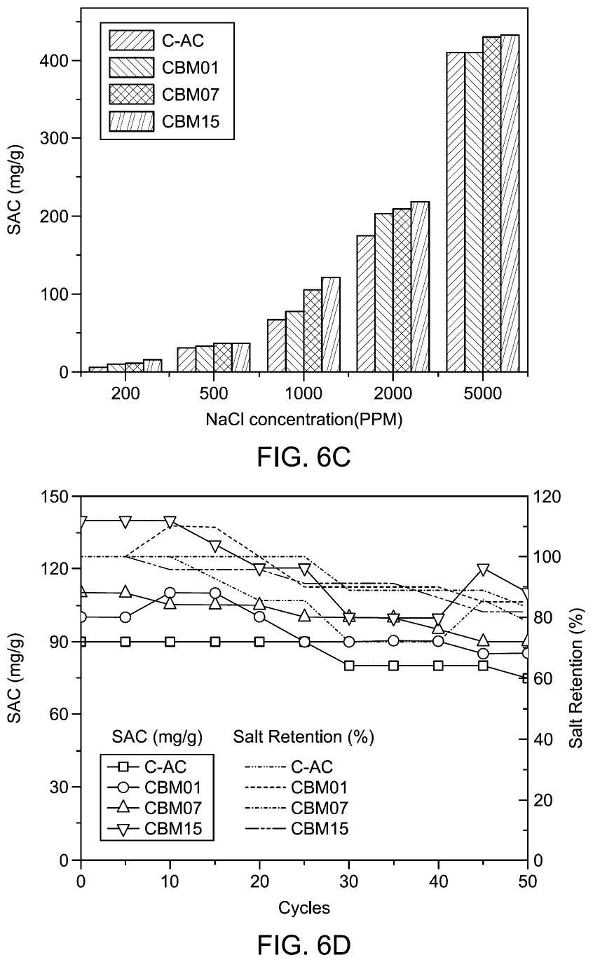

The desalination performances of the C-AC, CBM01, CBM07, and CBM15 electrodes is presented in FIGS. 6A-6D. The electrical conductivity vs time at a NaCl concentration of 1000 ppm is presented in FIG. 6A. As can be observed in FIG. 6A, the maximum decrease in the electrical conductivity was obtained by the electrode made of the CBM15 sample. For the shown one cycle in FIG. 6A, electrical conductivity decreased from 1.98 mS/cm to approximately 1.82 mS/cm. The SAC value obtained by this electrode is much higher than those obtained by the other electrodes made of the C-AC, CBM01, and CBM07 samples, as shown in FIG. 6B. The SAC value for the electrode made of the CBM15 sample reached around 124 mg/g at a NaCl concentration of 1000 ppm. The maximum ion removal rate was also higher in the case of the electrode made of the CBM15 sample, which recorded a value of 0.48 mg/g/s. This result showed that ball milling the carbonized date palm fronds for a longer time is effective for producing CDI electrodes with better performance.

The performance of each CDI electrode made of the C-AC, CBM01, CBM07, and CBM15 at different salt concentrations within the range of 200-5000 ppm is presented in FIG. 6C. Increasing the salt concentration is found to increase the SAC value linearly; however, the CDI electrodes made of the ball-milled samples at 7 and 15 h showed better SAC values than those of the samples without ball milling or ball milling for a short time. The electrode stability and salt retention of the electrodes made of the C-AC, CBM01, CBM07, and CBM15 were also investigated, and the obtained results are presented in FIG. 6D. Electrode stability was studied for 50 cycles at a salt concentration of 1000 ppm. Both the SAC value and salt retention are shown in FIG. 6D, with good stability in all the investigated electrodes observed. There is around a 10% decrease in values of the SAC and salt retention within the given number of cycles (50).

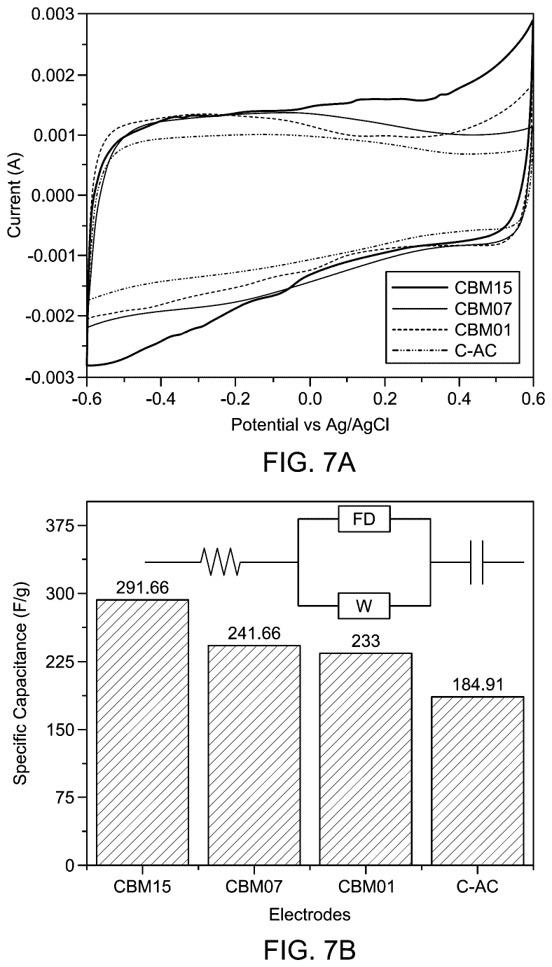

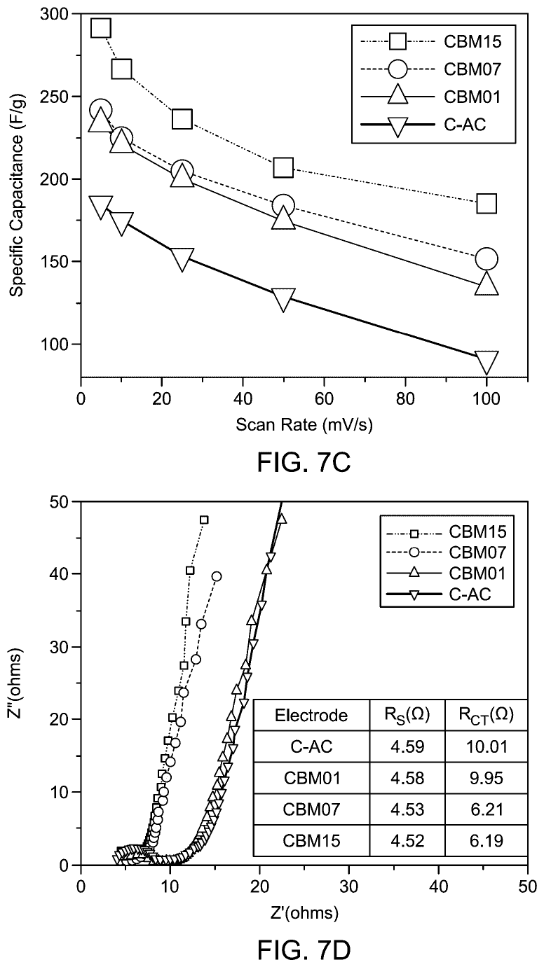

The electrochemical analysis of the electrodes made of the C-AC, CBM01, CBM07, and CBM15 samples was studied by cyclic voltammetry (CV) and electrochemical impedance spectroscopy (EIS). The obtained results are presented in FIGS. 7A-7D. In FIG. 7A, the CVs of the electrodes in the potential window range −0.6 to 0.6 V vs. Ag/AgCl at 5 mV s⁻¹ scan rate are shown. Quasi-rectangular shapes can be seen, which are typical for an electrochemical double-layer capacitor. The linear increase with an increase in the current density, observed mainly in the electrode made of the CBM15, is an indication of good electrochemical reversible behavior. The specific capacitance at a scan rate of 5 mV/s was evaluated by equation 1 described above. The obtained specific capacitance results are plotted in FIG. 7B. The highest value is found to be 291.66 F/g for the electrode made of the CBM15 sample, while the lowest value is of the C-AC sample, which only recorded 184.91 F/g. These results indicate the importance of the ball milling to reduce the particle size into ultrafine/nano sizes. As mentioned above, the surface area of the particles without ball milling is higher than those ball milled for different times. This might be due to the agglomeration of the ultrafine particles of the ball-milled carbonized date palm fronds, but this does not affect the electrochemical performance and the charge-discharge behavior of the electrodes made of the ball-milled carbonized date palm fronds.

The specific capacitance values for the electrodes made of the C-AC, CBM01, CBM07, and CBM15 samples at different scan rates were also studied, and the obtained results are shown in FIG. 7C. The scan rates were selected to be 5, 10, 25, 50, and 100 mV/s. By increasing the scan rate from 5 to 100 mV/s, systematic decreases within the range of 30-90% in the specific capacitance values can be observed. The electrode made of the CBM15 sample showed low decreases in the specific capacitance (about 30%) with increasing the scan rate, while the electrode made of the C-AC sample showed around a 90% decrease in the specific capacitance. The EIS for the electrodes made of the C-AC, CBM01, CBM07 and CBM15 samples was carried in 0.5 M NaCl solution, and the obtained results are presented in FIG. 7D. The charge transfer resistance is reduced for the ball-milled samples, particularly those ball-milled for 7 and 15 h. In addition, all the electrodes exhibit an almost quasi-vertical slope at the low-frequency range.

The performance and SAC efficiency of the CDI electrode made of the CBM15 are compared with those described in previous reports by other research groups. The results presented in Table 1 show that the present electrode has the highest SAC value at a salt concentration of 1000 ppm. This result shows that it is possible to use the ball milled carbonized date palm fronds to design effective CDI electrodes.

TABLE 1
Comparison of SAC efficiency of the CDI electrode made of the
CBM15 with those described in previous reports by other research
groups at salt concentrations within the range 500-1160 ppm.

| | | Initial | | |
|---|---|---|---|---|
| | Voltage | conc. | SAC | |
| Composite | (V) | (ppm) | (mg/g) | Ref. |
| Fluoride doped activated | 1.4 | 1000 | 12.4 | [1] |
| carbon cloth | | | | |
| Poly[N,N′-(ethane-1,2-diyl)- | 1.8 | 1000 | 54.2 | [2] |
| 1,4,5,8- | | | | |
| naphthalenetetracarboxiimide] | | | | |
| (PNDIE) | | | | |
| ZnO-Activated Carbon Cloth | 1.6 | 1000 | 7.7 | [3] |
| Nitrogen-doped three- | — | 1000 | 44.8 | [4] |
| dimensional (3D) nanofibrous | | | | |
| architectures from MXenes | | | | |
| Prussian blue analogue- | 1.0 | 1000 | 14.47 | [5] |
| modified carbon cloth | | | | |
| (PBAs/CC) | | | | |
| Activated biochar - | 1.2 | 1000 | 92.8 | [6] |
| manganese dioxide indirect | | | | |
| liquid-phase combination | | | | |
| Flow through capacitive | 2 | 1000 | 7.36 | [7] |
| deionization | | | | |
| Ordered mesoporous polymer | 1.2 | 584 | 14.8 | [8] |
| (OMP) precursor and o- | | | | |
| OMCs | | | | |
| Na₃V₂(PO₄)₃@C | 1 | 1000 | 75 | [9] |
| Carbonization, the relevant | 1.6 | 500 | 63.83 | [10] |
| porous carbon nanofibers | | | | |
| Nafion-coated activated | 1.2 | 584 | 44.5 | [11] |
| carbon electrodes | | | | |
| Nickel hexacyanoferrate | 1.0 | 1160 | 35 | |
| CBM15 | 1.6 | 1000 | 124 | This work |

[1] E. Toledo-Carrillo, X. Zhang, K. Laxman, J. Dutta, Asymmetric electrode capacitive deionization for energy efficient desalination, Electrochimica Acta, 358 (2020) 136939;
[2] Y. Li, Z. Ding, J. Li, J. Li, T. Lu, L. Pan, Highly efficient and stable desalination via novel hybrid capacitive deionization with redox-active polyimide cathode, Desalination, 469 (2019) 114098;
[3] K. Laxman, M. T. Z. Myint, R. Khan, T. Pervez, J. Dutta, Improved desalination by zinc oxide nanorod induced electric field enhancement in capacitive deionization of brackish water, Desalination, 359 (2015) 64-70;
[4] Z. Ding, X. Xu, J. Li, Y. Li, K. Wang, T. Lu, M. S. A. Hossain, M. A. Amin, S. Zhang, L. Pan, Y. Yamauchi, Nanoarchitectonics from 2D to 3D: MXenes-derived nitrogen-doped 3D nanofibrous architecture for extraordinarily-fast capacitive deionization, Chemical Engineering Journal, 430 (2022) 133161;
[5] X. Zhang, J. Dutta, X-Fe (X = Mn, Co, Cu) Prussian Blue Analogue-Modified Carbon Cloth Electrodes for Capacitive Deionization, ACS Applied Energy Materials, 4 (2021) 8275-8284;
[6] J. Adorna Jr, M. G. Borines, R. A. Doong, Capacitive deionization utilizing Activated Biochar - Manganese Dioxide (AB - MD) nanocomposites for desalination applications, IOP Conference Series: Materials Science and Engineering, 778 (2020) 012161;
[7] K. Dehghan, S. A. Mirbagheri, M. Alam, Investigation of effective parameters on brackish water desalination by flow-electrode capacitive deionization, Water Supply, 22 (2022) 5176-5189;
[8] X. Xu, H. Tan, Z. Wang, C. Wang, L. Pan, Y. V. Kaneti, T. Yang, Y. Yamauchi, Extraordinary capacitive deionization performance of highly-ordered mesoporous carbon nano-polyhedra for brackish water desalination, Environmental Science: Nano, 6 (2019) 981-989;
[9] J. Cao, Y. Wang, L. Wang, F. Yu, J. Ma, Na3V2 (PO4) 3@ C as faradaic electrodes in capacitive deionization for high-performance desalination, Nano letters, 19 (2019) 823-828;
[10] H. Zhang, J. Tian, X. Cui, J. Li, Z. Zhu, Highly mesoporous carbon nanofiber electrodes with ultrahigh specific surface area for efficient capacitive deionization, Carbon, 201 (2023) 920-929;
[11] J. Lee, K. Jo, J. Lee, S. P. Hong, S. Kim, J. Yoon, Rocking-chair capacitive deionization for continuous brackish water desalination, ACS Sustainable Chemistry & Engineering, 6 (2018) 10815-10822; and
[12] K. Singh, L. Zhang, H. Zuilhof, L. De Smet, Water desalination with nickel hexacyanoferrate electrodes in capacitive deionization: Experiment, model and comparison with carbon, Desalination, 496 (2020) 114647, each of which are incorporated herein by reference in their entireties.

### 3D Carbonized Chitosan

### Example 6: Materials

Chitosan (medium molecular weight) supplied from Sigma Aldrich, Germany, was used as a binder. Single-wall carbon nanotubes (SWCNTs) of high electrical conductivity (>1000 S/cm) were purchased from Ad-Nano Technologies (Shimoga, Karnataka, India). Acetic acid (CH₃COOH, Assay 99.5 wt. %) was supplied from Sigma Aldrich, Germany. Glutaraldehyde solution (supplied by Honeywell Fluka, USA) was used as a linker.

To dissolve chitosan, the pH of water was decreased by adding 0.1 mL of acetic acid in 10 mL of DI water, then 150 mg of chitosan was added into the acidic solution and stirred for 15 min at 50° C. SWCNTs (10 mg) and activated carbon nanoparticles of date palm fronds (300 mg) were added to and mixed vigorously with the chitosan solution with the help of a probe sonicator, then a glutaraldehyde linker at a concentration of 0.01 wt. % was added and again stirred for 10 min. The obtained slurry was frozen at −20° C. for 24 h, followed by freeze drying for 24 h at −42° C. The acquired dried electrodes were carbonized in the nitrogen atmosphere at 350° C. for 2 h.

The nitrogen adsorption isotherm was evaluated by using the 1200e Quantachorome instrument, USA. The surface area was calculated using the multi-Point BET method in the relative pressure range of 0.03-0.5. The pore distribution was evaluated by the Barrett, Joyner, and Halenda (BJH) method. The mesopore volume was calculated by subtracting micropore volume from the total volume of the absorbed. The Raman spectra were performed with a 532 nm laser. The surface and cross-section morphology of the electrode was investigated using FESEM JEOL, Japan (JSM-7600F).

Cyclic voltammetry (CV) tests and electrochemical impedance spectroscopy (EIS) were performed in 0.5 M NaCl electrolyte by using an electrode system with Ag/AgCl as a reference electrode, platinum rod as a counter electrode, and chitosan electrode as a working electrode. The CV was performed in the potential window range −1 to 1 V vs. Ag/AgCl and EIS in the range of 5 mHz to 10⁶ Hz.

The performance of the electrode was conducted in the batch mode method in which the water flows in a cycle through the CDI unit. The CDI unit consists of a titanium current collector enclosed between the acrylic sheets. A pair of chitosan electrodes of thickness 0.3 mm, each separated by an insulating spacer, were installed in between the current collectors. The NaCl solution of different concentrations was allowed to go through the electrodes with the help of a peristaltic pump at the flow rate of 17 mL/min. A potential difference of 1.6 V vs. Ag/AgCl was connected across the current collectors and a multi-meter was connected in series to measure the current flows in the circuit. A conductivity sensor was placed in the NaCl solution beaker to measure the change in the conductivity of water to convert the change in conductivity into total dissolved solids (TDS).

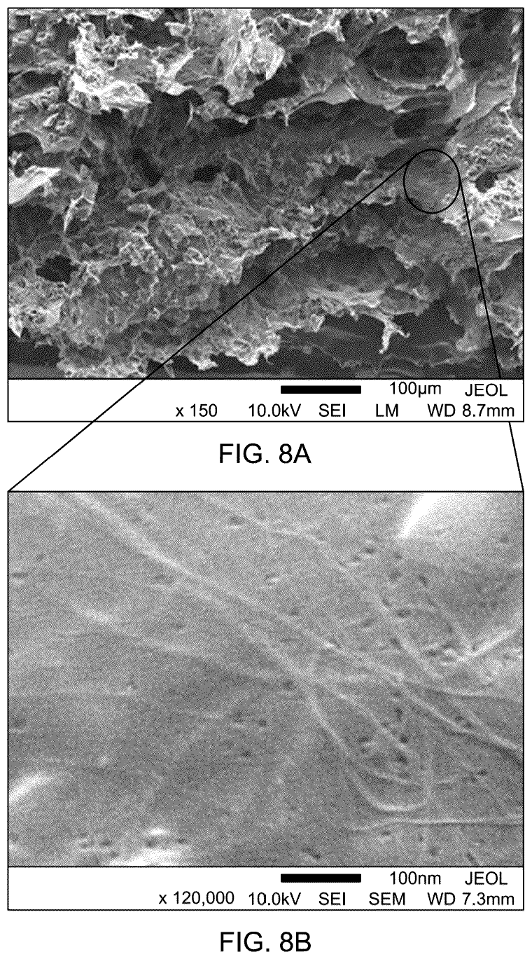

The surface morphology of the produced electrode made of carbonized chitosan is shown in FIGS. 8A-8B. FIGS. 8A-8B shows two SEM images of the produced electrode made of carbonized chitosan obtained at different magnifications. The images show a highly porous 3D structure (FIG. 8A). Micro-sized pores can be noticed with many various sizes of cavities seen in the structure. The high-magnification SEM image presented in FIG. 8B shows nano-sized porous at the surface of the carbonized chitosan, which might be due to the carbonization that induced surface activation. FIG. 8B also shows well distributed SWCNTs impeded in the structure. The 3D structure with the induced nano- and micropores may be used for CDI application. The material is light in weight and can accumulate salt ions within the nano and micropores.

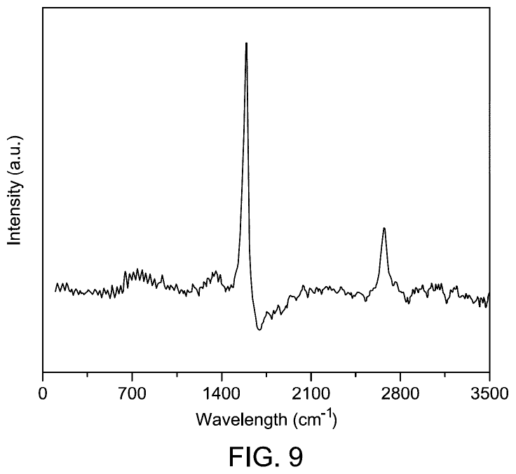

FIG. 9 shows the Raman spectrum of the electrode made of the carbonized chitosan. The peaks in this spectrum clearly the graphite (G band at around 1590 cm⁻¹), defect (D band at around 1350 cm⁻¹), and 2D bands (at around 2700 cm⁻¹), which are observed in graphitic carbons. The bands are pronounced in the electrode made of the carbonized chitosan. A small broadband is also observed at around 700 cm⁻¹. The sharp G and 2D bands may be attributed to the SWCNTs.

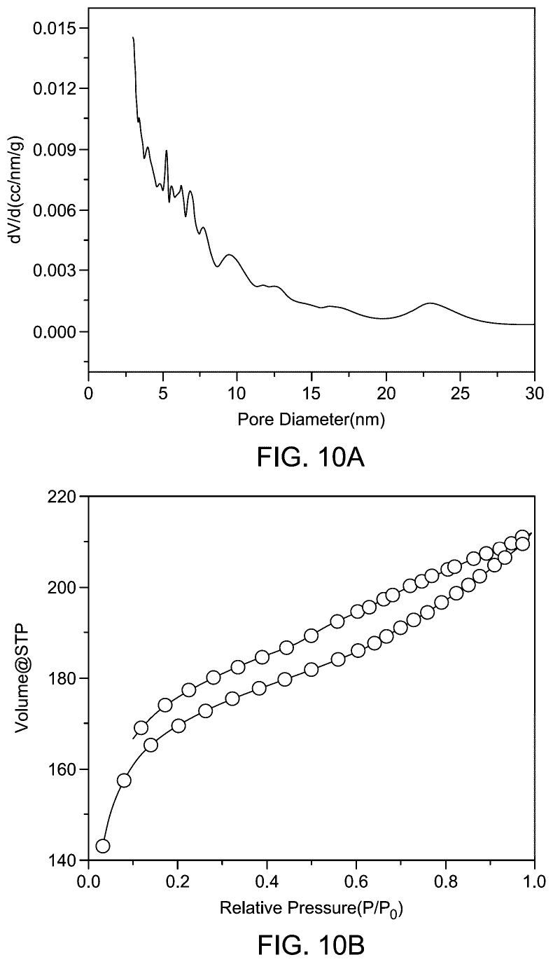

The pore profile observed in the electrodes made of carbonized chitosan was investigated using the BJH method. The BJH pore size distribution is shown in FIG. 10A, while the nitrogen adsorption/desorption isotherms in the relative pressure range 0.02 to 0.99 are shown in FIG. 10B. The majority of pore diameters are less than 5 nm in the carbonized chitosan electrode, with a portion above 5 nm. The shape of the isotherm curve is of type-IV, which indicates a mesoporous structure. Moreover, the existence of a type H3 loop in this electrode is due to the slit-shaped pores characterized by the carbonized chitosan.

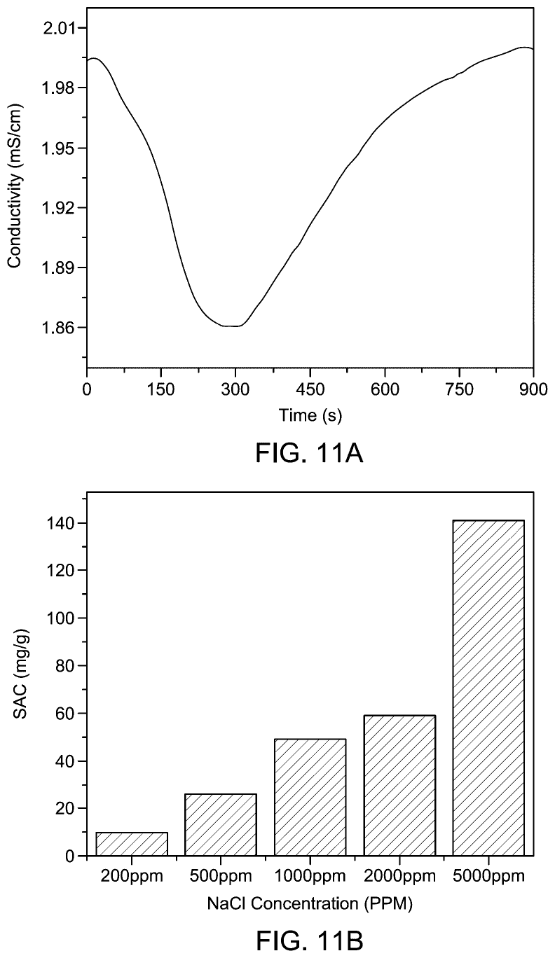

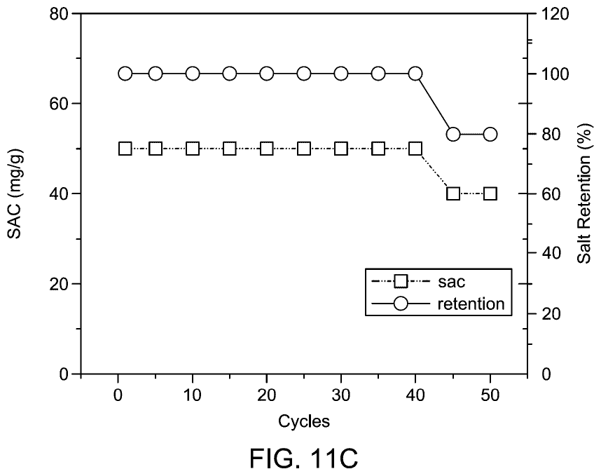

FIGS. 11A-11C show the desalination performance of the produced CDI electrode made of carbonized chitosan. The electrical conductivity vs time at a salt concentration of 1000 ppm is presented in FIG. 11A. In one cycle, the electrical conductivity decreased from around 2 mS/cm to 1.86 mS/cm. The performance of the CDI electrode made of carbonized chitosan at different salt concentrations within the range of 200-5000 ppm is presented in FIG. 11B. Increasing the salt concentration, also increases the salt absorption capacity (SAC). At 1000 ppm, the recorded SAC is found to be 50 mg/g, while at 5000 ppm, the SAC reached 142 mg/g. The CDI electrode stability and salt retention of the electrode made of the carbonized chitosan were also investigated, and the obtained results are presented in FIG. 11C. This stability was studied for 50 cycles at a salt concentration of 1000 ppm. Excellent results with good stability in the investigated electrode are observed. Decreases of about 20% in values of the SAC and salt retention are observed after 40 cycles.

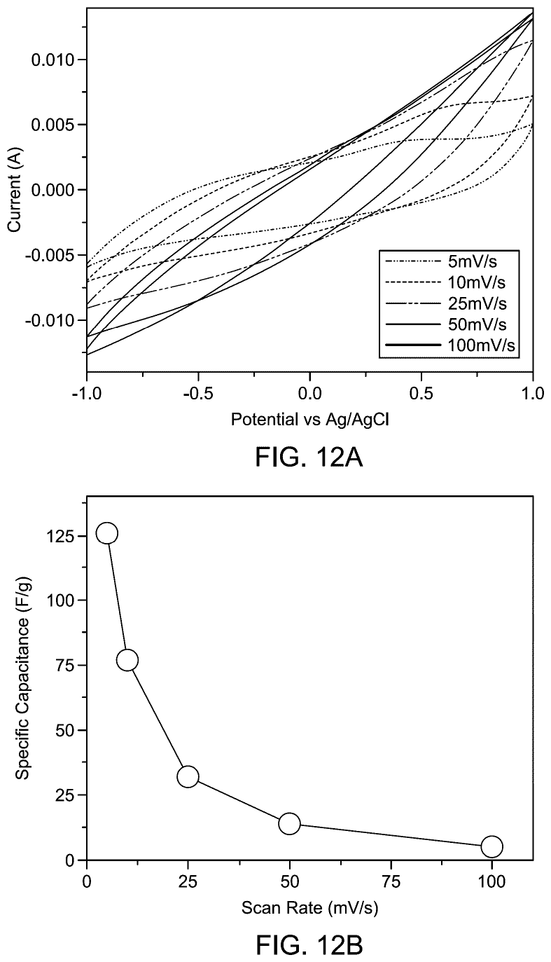

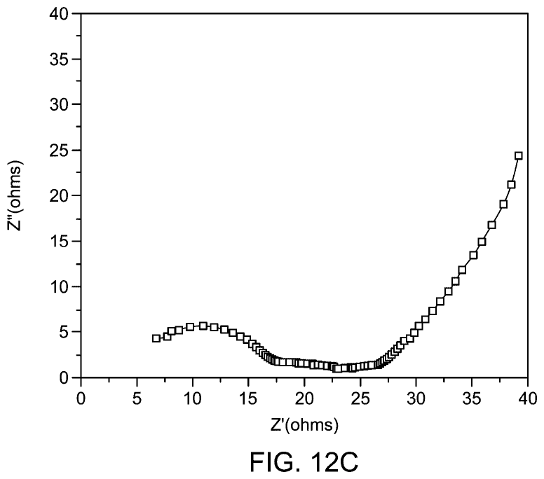

Electrochemical analysis of the electrode made of the carbonized chitosan was studied by cyclic voltammetry (CV) and electrochemical impedance spectroscopy (EIS). The obtained results are presented in FIGS. 12A-12C. In FIG. 12A, the voltammogram of the electrode made of the carbonized chitosan is studied in the potential window range −1 to 1 V Ag/AgCl at different scan rates is shown. Quasi-rectangular shapes can be seen, which are typical for an electrochemical double-layer capacitor. The linear increase with an increase in the current density is an indication of good electrochemical reversible behavior. The specific capacitance at different scan rates was evaluated by the equation 1 described above. The varied scan rates were selected to be 5, 10, 25, 50, and 100 mv/s and the obtained results are plotted in FIG. 12B. The specific capacitance value at the scan rate of 5 mV/s is found to be 125 F/g for the electrode made of the carbonized chitosan. The specific capacitance value decreases by increasing the scan rate. The value decreased to approximately 5 F/g at the scan rate of 100 mV/s.

EIS for the electrode made of the carbonized chitosan was carried in 0.5 M NaCl solution and the obtained results are presented in FIG. 12C. The observed semicircle in the obtained curve with a small diameter in the Nyquist plot of the carbonized chitosan electrode reveals that the charge transfer resistance value is relatively small due to an increase in specific surface area. In addition, this electrode exhibits an almost quasi vertical slope in low frequency range.

The CDI performance of different 3D materials reported in the literature were also reviewed and summarized in Table 2. The performance of the present CDI electrode made of the 3D carbonized chitosan has an SAC value of 50 mg/g at a salt concentration of 1000 ppm. This result provides high potential to utilize abundant chitosan for CDI application. The antimicrobial property of this material is also another great advantage to produce fresh water with no biological contaminations.

TABLE 2
CDI performance of different 3D materials reported
in the literature for compassion with the present
CDI electrode made of the 3D carbonized chitosan.

| | | Initial | | |
|---|---|---|---|---|
| | Voltage | conc. | SAC | |
| Composite | (V) | (ppm) | (mg/g) | Ref. |
| 3D-ordered honeycomb- | 1.2 | 500 | 21.45 | [1] |
| like nitrogen-doped | | | | |
| micro-mesoporous | | | | |
| carbon materials | | | | |
| 3D Highly ordered | 1.2 | 210 | 14.58 | [2] |
| mesoporous carbon nano- | | | | |
| polyhedra | | | | |
| 3D hierarchical carbon | 1.2 | 500 | 17.83 | [3] |
| architectures with micro- | | | | |
| meso and macropores | | | | |
| 3D Graphene | 1.6 | 500 | 15.00 | [4] |
| Architecture with | | | | |
| Nanopores | | | | |
| Three-dimensional (3D) | 1.2 | 5000 | 26.8 | [5] |
| holey graphene hydrogel | | | | |
| (HGH) | | | | |
| 3D porous carbon | 1.2 | 500 | 16.98 | [6] |
| polyhedra network | | | | |
| Micro-meso-macroporous | 1.2 | 1000 | 9.37 | [7] |
| 3-dimensional graphene | | | | |
| Three-dimensional | 0.8 | 2000 | 15.75 | |
| electrode design with | | | | |
| conductive fibers and | | | | |
| ordered macropores | | | | |
| 3D carbonized chitosan | 1.6 | 1000 | 50.00 | This work |

[1] X. Song, D. Fang, S. Huo, K. Li, 3D-ordered honeycomb-like nitrogen-doped micro-mesoporous carbon for brackish water desalination using capacitive deionization, Environmental Science: Nano, 8 (2021) 2191-2203;
[2] X. Xu, H. Tan, Z. Wang, C. Wang, L. Pan, Y. V. Kaneti, T. Yang, Y. Yamauchi, Extraordinary capacitive deionization performance of highly-ordered mesoporous carbon nano-polyhedra for brackish water desalination, Environmental Science: Nano, 6 (2019) 981-989;
[3] S. Zhao, T. Yan, H. Wang, J. Zhang, L. Shi, D. Zhang, Creating 3D Hierarchical Carbon Architectures with Micro-, Meso-, and Macropores via a Simple Self-Blowing Strategy for a Flow-through Deionization Capacitor, ACS Applied Materials & Interfaces, 8 (2016) 18027-18035;
[4] W. Shi, H. Li, X. Cao, Z. Y. Leong, J. Zhang, T. Chen, H. Zhang, H. Y. Yang, Ultrahigh Performance of Novel Capacitive Deionization Electrodes based on A Three-Dimensional Graphene Architecture with Nanopores, Scientific Reports, 6 (2016) 18966;
[5] W. Kong, X. Duan, Y. Ge, H. Liu, J. Hu, X. Duan, Holey graphene hydrogel with in-plane pores for high-performance capacitive desalination, Nano Research, 9 (2016) 2458-2466;
[6] Y. Liu, J. Ma, T. Lu, L. Pan, Electrospun carbon nanofibers reinforced 3D porous carbon polyhedra network derived from metal-organic frameworks for capacitive deionization, Scientific Reports, 6 (2016) 32784;
[7] J. Kang, J. Min, S.-I. Kim, S.-W. Kim, J.-H. Jang, Three-level micro-meso-macroporous three-dimensional graphene for highly fast capacitive deionization, Materials Today Energy, 18 (2020) 100502; and
[8] L. Liu, C. Zhao, F. Zheng, D. Deng, M. A. Anderson, Y. Wang, Three-dimensional electrode design with conductive fibers and ordered macropores for enhanced capacitive deionization performance, Desalination, 498 (2021) 114794, each of which are incorporated herein by reference in their entireties.

Numerous modifications and variations of the present disclosure are possible in light of the above teachings. Therefore, it is to be understood that within the scope of the appended claims, the disclosure may be practiced other than as specifically described herein.

1: A working electrode, including:
an outer layer including:
carbonized date palm frond carbon nanoparticles having a particle size of less than 100 nanometres (nm);
single-wall carbon nanotubes (SWCNTs);
a binder,
wherein the binder is a polyvinylidene fluoride, and
a graphite substrate on which the outer layer is disposed,
wherein the I_{D}/I_{G} ratio of the electrode measured in the Raman spectrum is 2.0 or greater.

2: The working electrode of claim 1, wherein the outer layer of the working electrode includes pores having a diameter of 20 to 2000 nm, globular clusters having the longest dimension of 500 to 5000 nm, and a network of nanowires, and wherein the working electrode has a salt adsorption capacity of at least 100 mg/g at a salt concentration of 1000 ppm and at least 400 mg/g at salt concentration of 5000 ppm.

3: The working electrode of claim 1, wherein the carbonized date palm frond carbon nanoparticles have a Brunauer-Emmett-Teller surface area of 900 to 1500 meters square per gram (m²/g).

4: The working electrode of claim 1, wherein the carbonized date palm frond carbon nanoparticles are made by a process, including:
carbonizing the date palm fronds at a temperature of 350 to 450 degrees Celsius (° C.) for 2 to 4 hours (h);
ball milling the carbonized date palm fronds for 0.5 to 16 h at a speed of 150 to 250 revolutions per minute (rpms);
mixing the ball milled carbonized date palm fronds with a base in water to form a solution, wherein the ball milled carbonized date palm fronds and the base have a weight ratio of 1:3 to 1:5,
heating the solution at a temperature of 550 to 650° C. for 1 to 3 h to form the chemically active carbon nanoparticles of date palm fronds.

5: The working electrode of claim 1, wherein the working electrode is made by a process, including:
dissolving the polyvinylidene fluoride in a polar solvent;
mixing the chemically active carbon nanoparticles of date palm fronds and the SWCNTs with the polyvinylidene fluoride in the polar solvent to form a mixture;
sonicating the mixture to form a slurry;
depositing the slurry on the graphite substrate; and
drying the slurry on the graphite substrate at a temperature of 100 to 120° C. for 4 to 6 h to form the working electrode,
wherein a weight ratio of the chemically active carbon nanoparticles of date palm fronds to the SWCNTs to the polyvinylidene fluoride is from 25 to 30:0.5 to 2:1 to 3.

6: A method of desalination, including:
contacting the working electrode of claim 1, a reference electrode, and a counter electrode with an aqueous solution in a feed tank,
wherein the reference electrode is a silver/silver chloride (Ag/AgCl) electrode,
wherein the counter electrode is a platinum electrode,
wherein the aqueous solution includes one or more salts,
connecting the working electrode, the reference electrode, and the counter electrode to a potentiostat;
circulating the aqueous solution through the feed tank;
applying a potential to the working electrode; and
absorbing the one or more salts.

7: The method of claim 6, wherein circulating occurs at a rate of 15 to 20 mL/minute.

8: The method of claim 6, wherein the applied voltage is from 1.5 to 1.7 volts (V) vs. Ag/AgCl.

9: The method of claim 6, wherein the aqueous solution has an initial concentration of the one or more salts of 1000 parts per million (ppm), and the working electrode has a salt adsorption capacity of 120 to 130 milligrams per gram (mg/g).

10: The method of claim 6, wherein the aqueous solution has an initial concentration of the one or more salts of 1000 ppm, and the working electrode has an ion removal rate of 0.45 to 0.50 milligrams per gram per second (mg/g/s).

11: The method of claim 6, wherein the aqueous solution has an initial concentration of the one or more salts of 1000 ppm, and the working electrode has a salt adsorption capacity of at least 80% of an initial salt adsorption capacity after 50 cycles, wherein one cycle is 900 seconds (s).

12: The working electrode of claim 1, wherein the working electrode has a specific capacitance of 230 to 300 Farad per gram (F/g) at a scan rate of 5 millivolts per second (mV/sec).

13: The working electrode of claim 1, wherein the working electrode has a charge transfer resistance of 5 to 7 oms (Q).

14: A working electrode, including:
an outer layer including:
a carbonized chitosan cryopolymerized material;
SWCNTs;
a linker,
wherein the linker is a glutaraldehyde, and
a graphite substrate on which the outer layer is disposed.

15: The working electrode of claim 14, wherein the outer layer of the working electrode is three-dimensional and includes nanopores, micropores, ridges, and valleys, wherein the ridges are 200 to 700 micrometers (μm) in length and the valleys are 50 to 300 μm in width between the ridges.

16: The working electrode of claim 14, wherein the working electrode is made by a process, including:
dissolving the chitosan in an acidic solution;
sonicating the SWCNTs with the chitosan in the acidic solution;
mixing the glutaraldehyde with the SWCNTs and the chitosan in the acidic solution to form a mixture;
depositing the mixture on the graphite substrate;
freezing the mixture on the graphite substrate at a first temperature of −10 to −30° C. for 20 to 28 h;
freezing the mixture on the graphite substrate at a second temperature of −35 to −45° C. for 20 to 28 h; and
carbonizing the mixture on the graphite substrate at a temperature of 300 to 400° C. for 1 to 3 h to form the working electrode.

17: A method of desalination, including:
contacting the working electrode of claim 14, a reference electrode, and a counter electrode with an aqueous solution in a feed tank,
wherein the reference electrode is a silver/silver chloride (Ag/AgCl) electrode,
wherein the counter electrode is a platinum electrode,
wherein the aqueous solution includes one or more salts,
connecting the working electrode, the reference electrode, and the counter electrode to a potentiostat;
circulating the aqueous solution through the feed tank;
applying a potential to the working electrode; and
absorbing the one or more salts.

18: The method of claim 17, wherein the aqueous solution has an initial concentration of the one or more salts of 1000 ppm, and the working electrode has a salt adsorption capacity of 45 to 55 mg/g.

19: The method of claim 17, wherein the aqueous solution has an initial concentration of the one or more salts of 1000 ppm, and the working electrode has a salt adsorption capacity of at least 80% of an initial salt adsorption capacity after 50 cycles, wherein one cycle is 900 s.

20: The working electrode of claim 14, wherein the working electrode has a specific capacitance of 130 to 140 F/g at a scan rate of 5 mV/sec.
